(19) United States
(12) Patent Application Publication
(10) Pub. No.: US 2023/0307613 A1
(43) Pub. Date: Sep. 28, 2023

(54) NOVEL COMPOSITES FOR ANODE ELECTRODES

(71) Applicant: OneD Material, Inc., Palo Alto, CA (US)

(72) Inventors: Yimin ZHU, Palo Alto, CA (US); Chunsheng DU, Palo Alto, CA (US); Zenan YU, Palo Alto, CA (US)

(73) Assignee: OneD Material, Inc., Palo Alto, CA (US)

(21) Appl. No.: 18/087,685

(22) Filed: Dec. 22, 2022

Related U.S. Application Data
(60) Provisional application No. 63/293,442, filed on Dec. 23, 2021.

(51) Int. Cl. H01M 4/36; H01M 4/583; H01M 4/38; H01M 4/62; H01M 4/04; H01M 4/66; H01M 10/0525

(52) U.S. Cl. CPC H01M 4/366; H01M 4/583; H01M 4/386; H01M 4/625; H01M 4/0471; H01M 4/622; H01M 4/0404; H01M 4/661; H01M 4/663; H01M 4/382; H01M 4/0435; H01M 4/0411; H01M 10/0525; H01M 2004/027

(57) ABSTRACT

Novel composites for use in battery anode electrodes are described. The novel composites include silicon-based nanostructures attached to a carbon-based substrate having a polymer disposed thereon, the polymer including monomeric units formed from styrene and allyl alcohol. The composites allow for the preparation of anode electrodes having low ratios of inactive materials to active materials, with improved processability according to both wet and dry anode coating techniques. Anode electrodes including the composites have improved uniformity and are more apt at accommodating volume changes during cycling.

### CROSS-REFERENCE TO RELATED APPLICATIONS

This application claims benefit under 35 U.S.C. § 119(e) of U.S. Provisional Application No. 63/293,442 filed Dec. 23, 2021, the contents of which are incorporated herein by reference in its entirety.

### TECHNICAL FIELD

The technology described herein relates to composites for use in battery anode electrodes, as well as to anode electrodes and batteries (e.g., lithium-ion batteries) comprising the composites, and processes for preparing the same. More particularly, the technology described herein relates to composites comprising silicon-based nanostructures attached to a carbon-based substrate, such as a carbon-based powder.

### BACKGROUND

There have been immense efforts focused on reducing cost and increasing performance for energy storage devices and the goal toward widespread adoption of Electric Vehicles (EVs) has greatly incentivized this endeavour. Strategies ranging from adopting novel anode active materials for performance improvement (e.g., silicon-carbon anode materials) to applying novel cell manufacturing processes for cost reduction (e.g., dry electrode coating or pre-lithiation) have been explored by many, with uncertain results that are mostly driven by the challenging trade off to combine new materials and large-scale production methods while at the same time reducing costs.

The manufacturing of high energy density anode electrodes for EV cells requires the mixing of active materials, such as silicon and graphite, and inactive materials, such as binders and conductive additives. Since inactive materials do not contribute to the reversible storage of lithium and electrons in the anode, there is a trend toward reducing the weight ratio of inactive materials to active materials in order to increase the EV cell energy density, while reducing its total weight. Furthermore, incorporating higher amounts of silicon, which has a higher specific capacity and a slightly higher voltage plateau than graphite, into the anode typically enables thinner anode electrodes that can be charged faster. However, the volume changes (up to 300%) associated with the alloying of lithium ions with the silicon are much greater than the volume changes associated with the intercalation of lithium ions into graphite (typically less than 10%). This poses significant challenges in the selection of polymer binders that can maintain the mechanical and electrical integrity of the anode layer and its adhesion to the current collector foil, whilst at the same time safely enabling higher silicon anode content and reducing manufacturing costs.

Some of the primary binders that have seen use in aqueous electrode fabrication for silicon-based anode electrodes are carboxymethyl cellulose (CMC) and Polyacrylic Acid (PAA). These binders are soluble in water and present high mechanical rigidity and stiffness. However, CMC and PAA used as the sole binder requires higher binder content in the silicon-graphite anode electrode layers (e.g., around 8 wt %) which may increase the anode rigidity and stiffness and may have a negative effect on the electrode winding process and on other critical production processes.

Another strategy employed today is to use styrene butadiene rubber (SBR) as a binder, with a view to improving flexibility, binding strength, adhesion and cohesion. However, SBR is hard to disperse uniformly in the electrode slurry, which can negatively impact electrode performance.

Elsewhere, efforts to advance silicon as a viable anode material for lithium-ion batteries have been typically directed towards one of the following approaches: (a) mixing small amounts of silicon oxide additives (e.g., SiOx with x close to a value of 1) with graphite particles, and/or (b) embedding silicon particles within carbon shell comprising amorphous carbon, hard carbon and/or a pyrolyzed polymer. In both approaches, the anode is formed by mixing the anode active materials with polymer binders to provide a slurry, which is then used to form an anode layer onto a copper current collector foil. However, these approaches present several drawbacks. For example, strategies according to approach (a) are technically complex and relatively costly, meaning that they are limited to formulations containing only small amounts of silicon, such that the resulting anodes exhibit a first cycle efficiency lower than 90%, thus necessitating costly cathode materials to compensate. Strategies according to approach (b) require a silicon precursor to form silicon particles and a carbon precursor to form a shell. The cost of producing these carbon shells is significant, as is the low conversion rate of the silicon precursor into reversible silicon capacity in the anode. Moreover, the new materials and particles involved in strategies according to these two approaches can have a significant effect on the rheology of the anode slurry, which in turn can compromise the homogeneity of the anode coating, the uniformity of silicon distribution within the anode layers and the adhesion of the anode layers onto the current collector foil.

### SUMMARY

Aspects of the present disclosure are directed to improved silicon-based anode materials that: have low ratio of inactive materials to active materials; provide improved processability; have increased slurry homogeneity and silicon distribution in the anode layer; may facilitate prelithiation processes; and/or are suitable for large scale production at competitive cost using current and future cell production equipment.

According to a first aspect, a composite is provided that comprises a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol.

According to a second aspect, a process for preparing a composite is provided, the process comprising: mixing: a plurality of silicon-based nanostructures attached to a carbon-based substrate, and a solution of a polymer to form a mixture, the polymer comprising monomeric units formed from styrene and allyl alcohol; and drying the mixture.

According to a third aspect, a composite obtained, directly obtained or obtainable by the process of the second aspect is provided.

According to a fourth aspect, an anode electrode is provided comprising a first anodic layer, the first anodic layer comprising a binder and a composite as described herein.

According to a fifth aspect, a process for preparing an anode electrode is provided, the process comprising: mixing a composite as described herein, and a binder; applying an anodic layer of the mixture resulting from the mixing.

According to a sixth aspect, an anode electrode obtained, directly obtained or obtainable by the process of the fifth aspect is provided.

According to a seventh aspect, a battery comprising a composite and/or an anode electrode as described herein is provided.

### BRIEF DESCRIPTION OF THE DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings:

FIG. 1A is a SEM (Scanning Electronic Microscope) picture which illustrates silicon-based nanowires attached to surfaces of a particle of uncoated natural graphite for use in composites in accordance with aspects of the invention.

FIGS. 1B and 1C are SEM pictures (1C is an enlarged view of the rectangular portion of 1B) that illustrate a section of a particle of uncoated natural graphite for use in composites in accordance with aspects of the invention. The particle has been cut using an FIB (focused ion beam) cutting technique to show the interior wall surfaces of pores in the graphite particle and the silicon-based nanowires attached thereon.

FIG. 2A is a flow diagram illustrating a process for preparing a composite in accordance with aspects of the invention.

FIG. 2B is a flow diagram illustrating a process for preparing a composite in accordance with aspects of the invention.

FIG. 3 is a flow diagram illustrating a process for preparing an anode electrode in accordance with aspects of the invention.

FIG. 4 illustrates curves showing the performance of half cells in accordance with aspects of the invention.

FIG. 5 illustrates curves showing the cycling performance of anodes in full cells in accordance with aspects of the invention.

FIG. 6 illustrates curves showing of half cells in accordance with aspects of the invention. FIGS. 6A-6C are detailed views of portions of the curves shown in FIG. 6.

FIGS. 7A and 7B show TEM images of silicon nanowires and graphite particles coated by a uniform PSAA carbonized layer in accordance with aspects of the present invention.

FIG. 8 shows cycling performance between a baseline battery cell and a battery cell in accordance with aspects of the invention using a first cycling protocol.

FIG. 9 shows cycling performance between a baseline battery cell and a battery cell in accordance with aspects of the invention using a second cycling protocol different from the first.

FIG. 10 shows the specifications, 1st charge capacity, and 1st discharge capacity of 4 sets of electrochemical comprising anode material composites comprising different combination of SiNW-carbon and PSAA.

FIG. 11 shows discharge specific capacity over hundreds of cycles for two types of electrochemical cells, the first type comprising an anode composite prepared using a single surface treatment and the second type comprising an anode composite prepared using a double surface treatment.

FIG. 12 shows % capacity retention over hundreds of cycles for two types of electrochemical cells, the first type comprising an anode composite prepared using a single surface treatment and the second type comprising an anode composite prepared using a double surface treatment.

### DETAILED DESCRIPTION

### Definitions

As used herein, a “nanostructure” is a structure having at least one region or characteristic dimension with a dimension of less than about 500 nm, e.g., less than about 200 nm, less than about 100 nm, less than about 50 nm, or even less than about 20 nm. Typically, the region or characteristic dimension will be along the smallest axis of the structure. Examples of such structures include nanowires, nanorods, nanotubes, nanofibers, nanoparticles, and the like. Nanostructures can be, e.g., substantially crystalline, substantially monocrystalline, polycrystalline, amorphous, or a combination thereof. In certain embodiments, each of the three dimensions of the nanostructure has a dimension of less than about 500 nm, e.g., less than about 200 nm, less than about 100 nm, less than about 50 nm, or even less than about 20 nm.

As used herein, an “aspect ratio” is the length of a first axis of a nanostructure divided by the average of the lengths of the second and third axes of the nanostructure, where the second and third axes are the two axes whose lengths are most nearly equal each other. For example, the aspect ratio for a perfect rod would be the length of its long axis divided by the diameter of a cross-section perpendicular to (normal to) the long axis.

As used herein, the “diameter” of a nanostructure refers to the diameter of a cross-section normal to a first axis of the nanostructure, where the first axis has the greatest difference in length with respect to the second and third axes (the second and third axes are the two axes whose lengths most nearly equal each other). The first axis is not necessarily the longest axis of the nanostructure; e.g., for a disk-shaped nanostructure, the cross-section would be a substantially circular cross-section normal to the short longitudinal axis of the disk. Where the cross-section is not circular, the diameter is the average of the major and minor axes of that cross-section. For an elongated or high aspect ratio nanostructure, such as a nanowire, the diameter is measured across a cross-section perpendicular to the longest axis of the nanowire. For a spherical nanostructure, the diameter is measured from one side to the other through the centre of the sphere.

As used herein, the terms “crystalline” or “substantially crystalline” when used with respect to nanostructures, refer to the fact that the nanostructures typically exhibit long-range ordering across one or more dimensions of the structure. It will be understood by one of skill in the art that the term “long range ordering” will depend on the absolute size of the specific nanostructures, as ordering for a single crystal cannot extend beyond the boundaries of the crystal. In this case, “long-range ordering” will mean substantial order across at least the majority of the dimension of the nanostructure. In some instances, a nanostructure can bear an oxide or other coating, or can be comprised of a core and at least one shell. In such instances it will be appreciated that the oxide, shell(s), or other coating need not exhibit such ordering (e.g. it can be amorphous, polycrystalline, or otherwise). In such instances, the phrase “crystalline,” “substantially crystalline,” “substantially monocrystalline,” or “monocrystalline” refers to the central core of the nanostructure (excluding any coating layers or shells). The terms “crystalline” or “substantially crystalline” as used herein are intended to also encompass structures comprising various defects, stacking faults, atomic substitutions, and the like, as long as the structure exhibits substantial long range ordering (e.g., order over at least about 80% of the length of at least one axis of the nanostructure or its core). In addition, it will be appreciated that the interface between a core and the outside of a nanostructure or between a core and an adjacent shell or between a shell and a second adjacent shell may contain non-crystalline regions and may even be amorphous. This does not prevent the nanostructure from being crystalline or substantially crystalline as defined herein.

As used herein, the term “monocrystalline” when used with respect to a nanostructure indicates that the nanostructure is substantially crystalline and comprises substantially a single crystal. When used with respect to a nanostructure heterostructure comprising a core and one or more shells, “monocrystalline” indicates that the core is substantially crystalline and comprises substantially a single crystal.

As used herein a “nanoparticle” is a nanostructure in which each dimension (e.g., each of the nanostructure's three dimensions) is less than about 500 nm, e.g., less than about 200 nm, less than about 100 nm, less than about 50 nm, or even less than about 20 nm. Nanoparticles can be of any shape, and include, for example, nanocrystals, substantially spherical particles (having an aspect ratio of about 0.8 to about 1.2), and irregularly shaped particles. Nanoparticles optionally have an aspect ratio less than about 1.5. Nanoparticles can be amorphous, crystalline, monocrystalline, partially crystalline, polycrystalline, or otherwise. Nanoparticles can be substantially homogeneous in material properties, or in certain embodiments can be heterogeneous (e.g., heterostructures). Nanoparticles can be fabricated from essentially any convenient material or materials, e.g., the nanoparticles can comprise “pure” materials, substantially pure materials, doped materials and the like.

A “nanowire” is a nanostructure that has one principal axis that is longer than the other two principal axes. Consequently, the nanowire has an aspect ratio greater than one; nanowires of this invention typically have an aspect ratio greater than about 1.5 or greater than about 2. Short nanowires, sometimes referred to as nanorods, typically have an aspect ratio between about 1.5 and about 10. Longer nanowires have an aspect ratio greater than about 10, greater than about 20, greater than about 50, or greater than about 100, or even greater than about 10,000. The diameter of a nanowire is typically less than about 500 nm, preferably less than about 200 nm, more preferably less than about 150 nm, and most preferably less than about 100 nm, about 50 nm, or about 25 nm, or even less than about 10 nm or about 5 nm. The nanowires can be substantially homogeneous in material properties or, in certain embodiments, can be heterogeneous (e.g., nanowire heterostructures). The nanowires can be fabricated from essentially any convenient material or materials. The nanowires can comprise “pure” materials, substantially pure materials, doped materials and the like, and can include insulators, conductors, and semiconductors. Nanowires are typically substantially crystalline and/or substantially monocrystalline, but can be, e.g., polycrystalline or amorphous. In some instances, a nanowire can bear an oxide or other coating, or can comprise a core and at least one shell. In such instances it will be appreciated that the oxide, shell(s), or other coating need not exhibit such ordering (e.g. it can be amorphous, polycrystalline, or otherwise). Nanowires can have a variable diameter or can have a substantially uniform diameter, that is, a diameter that shows a variance less than about 20% (e.g., less than about 10%, less than about 5%, or less than about 1%) over the region of greatest variability and over a linear dimension of at least 5 nm (e.g., at least 10 nm, at least 20 nm, or at least 50 nm). Typically, the diameter is evaluated away from the ends of the nanowire (e.g., over the central 20%, 40%, 50%, or 80% of the nanowire). A nanowire can be straight or can be, e.g., curved or bent, over the entire length of its long axis or a portion thereof. In certain embodiments, a nanowire or a portion thereof can exhibit two- or three-dimensional quantum confinement. Nanowires, in some embodiments, can expressly exclude carbon nanotubes, and, in certain embodiments, exclude “whiskers” or “nanowhiskers”, particularly whiskers having a diameter greater than 100 nm, or greater than about 200 nm.

As used herein, “silicon-based” when used in relation to nanostructures denotes that the nanostructures comprise at least about 50% silicon by mass. Suitably, a silicon-based nanostructure comprises at least about 60% silicon, at least about 70% silicon, at least about 80% silicon, at least about 90% silicon, at least about 95% silicon, or about 100% silicon by mass, including 100% silicon.

As used herein, “carbon-based substrate” refers to a porous substrate that comprises at least about 50% carbon by mass. Suitably, a carbon-based substrate comprises at least about 60% carbon, at least about 70% carbon, at least about 80% carbon, at least about 90% carbon, at least about 95% carbon, or about 100% carbon by mass, including 100% carbon. Carbon-based substrates can be in the form of sheets or separate particles, as well as cross-linked structures. Carbon-based substrates specifically exclude metallic materials, such as steel, including stainless steel. Typically, the carbon-based substrate is a graphite powder (e.g., artificial graphite powder or natural graphite powder). The graphite powder may be coated (e.g., carbon coated) or uncoated. Carbon-based substrate particles can be of essentially any desired shape, for example, spherical or substantially spherical, elongated, oval/oblong, plate-like (e.g., plates, flakes, or sheets), and/or the like. Similarly, the carbon-based substrate (e.g., graphite particles) can be of essentially any size and porosity. Typically, the carbon-based substrate (e.g. graphite particles) has a D₅₀ between about 0.5 μm to about 50 μm. It will be understood that D₅₀ refers to the median particle diameter corresponding to the 50th percentile of the cumulative undersize distribution. The measurement method used is laser diffraction according to ISO Standard Number 13320. Therefore, when, for example, the carbon-based substrate is a graphite powder, it will be understood that a D₅₀ of 0.5 μm to 50 μm means that a sample of the graphite powder has a D₅₀, when measured by laser diffraction according to ISO #13320, that is no less than 0.5 μm and is no greater than 50 μm. This measurement is commonly used in the specification of commercial carbon-based substrates (e.g. graphite powders) used by lithium ion battery manufacturers and is therefore well understood by those of skill in the art. The carbon-based substrate may alternatively have a D₅₀ of, for example, between about 0.5 μm and about 2 μm, between about 2 μm and about 10 μm, between about 2 μm and about 5 μm, between about 5 μm and about 50 μm, between about 10 μm and about 30 μm, between about 10 μm and about 20 μm, between about 15 μm and about 25 μm, between about 15 μm and about 20 μm, or about 20 μm. The graphite powder (e.g., coated or uncoated natural graphite powder or artificial graphite powder) may comprise particles comprising a plurality of pores disposed therein and a surface area which includes interior wall surfaces of the apertures that define the plurality of pores. As well-known from those skilled in the art, the porosity of graphite particles can be estimated from various types of measurements, for example: gas absorption surface area according to “BET” or “SSA” standards; direct FIB SEM imaging; mercury porosimetry. The standard definition for porosity, as found in ASTM Standard C709 which has definitions of terms relating to manufactured carbon and graphite, is “the percentage of the total volume of a material occupied by pores.” When one calculates the apparent density of a material, the pore volume is included in the calculation. This results in typical apparent densities of synthetic graphites of from 1.6 g/cm³ to 1.90 g/cm³, as compared to the theoretical density of graphite is 2.26 g/cm³ (the specific volume of graphite is the inverse of the specific density). The difference between the apparent density (particle weight divided by particle volume including the volume of the pores) and theoretical density (weight per unit volume in absence of pores) is the measure of the total pore volume per unit mass. Porosity can then be defined as the ratio of pore volume per unit mass divided by the sum of the specific volume and the pore volume per unit mass. Typical apparent (bulk) densities of natural graphites for anode applications falls within the range of from 1.2 g/cm³ to 2.14 g/cm³ when the natural graphite porosity falls within the range of from about 5% to about 50%.

The term “about” as used herein indicates the value of a given quantity varies by +/−10% of the value, or optionally +/−5% of the value, or in some embodiments, by +/−1% of the value so described.

Unless defined otherwise, all technical and scientific terms used herein have the same meaning as commonly understood by one of ordinary skill in the art to which the invention pertains. The following definitions supplement those in the art and are directed to the current application and are not to be imputed to any related or unrelated case, e.g., to any commonly owned patent or application. Although any methods and materials similar or equivalent to those described herein can be used in the practice, certain materials and methods are described herein. Accordingly, the terminology used herein is for the purpose of describing particular embodiments only, and is not intended to be limiting.

Throughout the entirety of the description and claims of this specification, where subject matter is described herein using the term “comprise” (or “comprises” or “comprising”), the same subject matter instead described using the term “consist of” (or “consists of” or “consisting of”) or “consist essentially of” (or “consists essentially of” or “consisting essentially of”) is also contemplated.

Throughout the description and claims of this specification, the singular encompasses the plural unless the context otherwise requires. In particular, where the indefinite article is used, the specification is to be understood as contemplating plurality as well as singularity, unless the context requires otherwise.

Features (and their relative suitability) described in conjunction with a particular aspect, embodiment or example are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any of the specific embodiments recited herein. The invention extends to any novel one, or any novel combination, of the features disclosed in this specification (including any accompanying claims, abstract and drawings), or to any novel one, or any novel combination, of the steps of any method or process so disclosed.

Unless otherwise specified, where the quantity or concentration of a particular component of a given product is specified as a weight percentage (% by mass, wt % or % w/w), said weight percentage refers to the percentage of said component by weight relative to the total weight of the product as a whole. It will be understood by those skilled in the art that the sum of weight percentages of all components of a product will total 100 wt %. However, where not all components are listed (e.g. where a product is said to “comprise” one or more particular components), the weight percentage balance may optionally be made up to 100 wt % by unspecified ingredients.

Unless otherwise specified, where a range is provided, the value may be any value or range of values within the range.

### Composites and Preparation Thereof.

In one aspect, embodiments provide a composite comprising a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol.

As a result of rigorous investigation, the inventors have surprisingly found that the application of a polymer comprising monomeric moieties formed from styrene and allyl alcohol to silicon-based nanostructures attached to a carbon-based substrate greatly enhances the dispersive and binding capabilities of the resulting composite, allowing the composite to be straightforwardly and inexpensively processed with other active and inactive materials (e.g. binders, conductive additive, etc.) to form highly uniform anode materials. In particular, the inventors have determined that the characteristics of the polymer disposed on the silicon-based nanostructures and carbon-based substrate engender favourable binding interactions with those materials commonly employed as binders in the preparation of battery anode materials. This improved interaction between anode slurry components allows for the preparation of anode materials having a high ratio of active to inactive materials using both wet and dry processing techniques, and also a longer cycle life, i.e. the ability to provide higher anode reversible capacity over more charge/discharge cycles, even when the charging or discharging include higher currents. Moreover, the polymer-comprising monomeric moieties formed from styrene and allyl alcohol is able to form a more stable interface between the silicon-based nanostructures and semi solid/solid-state electrolytes, demonstrating an improved ability to withstand volume changes that occur in the silicon-based nanostructures during charge/discharge cycles. As a consequence of the above, batteries incorporating the composites described herein offer improved electronic properties (e.g. specific capacity and/or initial coulombic efficiency (ICE) and/or capacity retention over many charge/discharge cycles, even at high C-rates).

The composites are suitable for use in an anode electrode, in particular an anode electrode of a lithium-ion battery.

With regard to the polymer disposed on the plurality of silicon-based nanostructures and the carbon-based substrate, it will be understood that a monomeric unit formed from styrene refers to the repeating unit whose repetition would produce a polystyrene chain (disregarding end groups). Similarly, it will be understood that a monomeric unit formed from allyl alcohol (i.e. prop-2-en-1-ol) refers to the repeating unit whose repetition would produce a poly(allyl alcohol) chain (disregarding end groups). The monomeric units formed from styrene and allyl alcohol are depicted below:

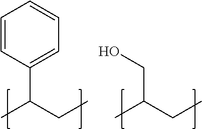

Without wishing to be bound by theory, the inventors have hypothesised that the structure and/or properties of the polymers comprising monomeric units formed from styrene and allyl alcohol facilitate improved interaction with other anode slurry components, which in turn confers improved dispersibility of the silicon-based nanostructures attached to the carbon-based substrate, leading to more uniform anode materials. In particular, the functional groups/structural motifs present on the polymer are free to participate in intermolecular interactions with functional groups/structural motifs that may be present on binders included in the slurry. By way of example, the hydroxyl group of the polymer may participate in hydrogen bonding with groups present on the binder (e.g. hydroxyl groups present on carboxy methyl cellulose) and/or the phenyl group of the polymer may participate in π-π stacking with groups present on the binder (e.g. phenyl groups present on styrene-butadiene rubber). Improved dispersibility of the silicon-based nanostructures attached to the carbon-based substrate is particularly important when anodic materials are to be prepared by a dry coating technique, e.g. when a solid mixture of the silicon-based nanostructures attached to the carbon-based substrate is dispersed in a thermoplastic polymer binder (e.g. polytetrafluoroethylene) under solvent-free conditions and then laminated as a film onto a current collector.

The polymer comprising monomeric units formed from styrene and allyl alcohol may form a coating (e.g. a partial or complete coating) on the silicon-based nanostructures and the carbon-based substrate. Suitably, the polymer is disposed (e.g. coated) onto the silicon-based nanostructures and the carbon-based substrate in a substantially uniform manner.

The polymer comprising monomeric units formed from styrene and allyl alcohol suitably has a softening point of less than 200° C. Such polymers typically demonstrate better compatibility with binders used in anode slurries. More suitably, the polymer has a softening point of 50° C. to 100° C. Most suitably, the polymer has a softening point of 60° C. to 90° C.

The polymer comprising monomeric units formed from styrene and allyl alcohol may have a molecular weight (Mₙ) determined by gas permeation chromatography (GPC) of 800 g mol⁻¹ to 5000 g mol⁻¹. Suitably, the polymer has a molecular weight (Mₙ) of 1000 g mol⁻¹ to 3000 g mol⁻¹. Most suitably, the polymer has a molecular weight (Mₙ) of 1200 g mol⁻¹ to 2000 g mol⁻¹.

The polymer comprising monomeric units formed from styrene and allyl alcohol is suitably soluble in alcoholic solvents, in particular ethanol. Polymers displaying these solubility characteristics facilitate drying of the resulting composite. In contrast to the use of water-soluble polymers, solutions of polymers that are soluble in, e.g., ethanol can be straightforwardly dried at lower temperatures, without leaving any solvent residues on the silicon-based nanostructures, which can negatively impact battery performance. More suitably, the polymer is insoluble in water. The polymer may be insoluble in carbonate-based electrolytes, such as those used in the preparation of lithium-ion batteries. Suitably, the ethanol may be recovered during the drying process and re-used, which leads to lower costs and waste.

The polymer comprising monomeric units formed from styrene and allyl alcohol may comprise at least 20 mol % (e.g. 20 mol % to 50 mol %) of monomeric units formed from allyl alcohol. Suitably, the polymer comprises 25 mol % to 45 mol % of monomeric units formed from allyl alcohol. Most suitably, the polymer comprises 30 mol % to 36 mol % of monomeric units formed from allyl alcohol. Additionally, the polymer may comprise at least 50 mol % of monomeric units formed from styrene.

In particular embodiments, the polymer comprising monomeric units formed from styrene and allyl alcohol is poly(styrene-co-allyl alcohol) (PSAA). The polymer may have any of the aforementioned properties. PSAA is an inexpensive, environmentally friendly and non-toxic polymer, that is readily soluble in ethanol.

The composite may comprise 0.1 wt % to 10 wt % of the polymer comprising monomeric units formed from styrene and allyl alcohol (e.g. PSAA). Suitably, the composite comprises 0.5 wt % to 5 wt % (e.g. 0.7 wt % to 2 wt %) of the polymer.

The silicon-based nanostructures are attached to the carbon-based substrate such that they are in electrical communication with one another. Typically, the silicon-based nanostructures are attached to external surfaces of the carbon-based substrate. However, when the carbon-based substrate is porous (e.g., a porous graphite powder), the silicon-based nanostructures may be attached to both internal surfaces (those surfaces defining the pores) and external surfaces of the carbon-based substrate. This can be achieved by a number of techniques known in art. For example, silicon-based nanostructures (e.g. silicon nanowires) can be grown from catalyst particles deposited on carbon-based substrates (e.g. graphite particles) via a vapor-liquid-solid (VLS), or a vapor-solid-solid (VSS) chemical vapor deposition techniques. Alternatively, silicon-based nanostructures (e.g. silicon nanowires) can be electrochemically deposited onto carbon-based substrates (e.g. graphite particles). Reference is made to U.S. Pat. No. 10,243,207 or 9,812,699 which are incorporated by reference herein in their entireties. In some embodiments, the silicon-based nanostructures are mechanically attached to the carbon-based substrate. In some embodiments, the silicon-based nanostructures are attached to the carbon-based substrate such that they are in electrical communication with one another without requiring the use of conductive polymers to achieve the mechanical and electrical connections. In some embodiments, the electrical communication is via a low electrical impedance path during cycling.

In particular embodiments, the silicon-based nanostructures are suitably silicon-based nanowires, such as silicon nanowires. Dimensions of the silicon-based nanostructures (e.g. silicon nanowires) are described hereinbefore. Suitably, the silicon-based nanowires (e.g. silicon nanowires) have diameters in the range of 10 nm to 200 nm. The silicon-based nanostructures may comprise a monocrystalline core and a shell layer, wherein the shell layer comprises amorphous silicon, polycrystalline silicon, or a combination thereof.

The carbon-based substrate is provided as a plurality of particles, with the silicon-based nanostructures being attached to those particles (e.g., to the surfaces of those particles). Some particles may have more silicon-based nanostructure attached to them than others. The carbon-based substrate may be selected from graphite powder (e.g., artificial graphite powder or natural graphite powder), which may be coated (e.g., carbon coated) or uncoated, mesocarbon microbead powder (also called “MCMB” in industrial applications) or a combination thereof. Most suitably, the carbon-based substrate is graphite powder. Dimensions of the carbon-based substrate are described hereinbefore. Suitably, the carbon-based substrate (e.g., a graphite powder) has a D₅₀ in a range of about 5 μm to about 50 μm measured according to industry standard practices and equipment. Suitably, the carbon-based substrate (e.g., a graphite powder) has a porosity in a range of about 10% to 30% measured according to methods known in the art and described above. In the examples provided herein, the Brunauer-Emmett-Teller (BET) measuring method and the direct FIB SEM imaging method were used to measure the pores and to visualize the nanowires and PSAA coating, as shown in the Figures.

The plurality of silicon-based nanostructures (e.g. silicon nanowires) and the carbon-based substrate (e.g. graphite powder) may collectively account for 90 wt % of the composite. Suitably, the plurality of silicon-based nanostructures and the carbon-based substrate may collectively account for 95 wt % of the composite.

In embodiments, the silicon-based nanostructures are silicon nanowires having diameters in the range of 10 nm to 200 nm. Suitably, the silicon nanowires and the carbon-based powder account for 90 wt % of the composite.

The plurality of silicon-based nanostructures (e.g. silicon nanowires) attached to a carbon-based substrate (e.g. a graphite powder) may comprise 1 wt % to 40 wt % silicon. Suitably, the plurality of silicon-based nanostructures attached to a carbon-based substrate comprises 2.5 wt % to 25 wt % silicon. Most suitably, the plurality of silicon-based nanostructures attached to a carbon-based substrate comprises 5 wt % to 15 wt % silicon (e.g., 8 wt % to 11 wt % silicon).

In embodiments, the silicon-based nanostructures are silicon nanowires having diameters in the range of 10 nm to 200 nm and the carbon-based substrate is graphite powder having a D₅₀ in the range of 5 μm to 50 μm. Suitably, the silicon nanowires attached to the graphite powder comprises 1 wt % to 40 wt % (e.g., 5 wt % to 15 wt %) silicon.

In embodiments, the composite comprises 90 wt % of the plurality of silicon-based nanostructures (e.g., silicon nanowires) and the carbon-based substrate (e.g., graphite powder), and 0.1 wt % to 10 wt % of the polymer comprising monomeric units formed from styrene and allyl alcohol (e.g. PSAA). Suitably, the composite comprises 95 wt % of the plurality of silicon-based nanostructures and the carbon-based substrate, and 0.5 wt % to 5 wt % (e.g., 0.7 wt % to 2 wt %) of the polymer comprising monomeric units formed from styrene and allyl alcohol. Silicon may account for 2 wt % to 40 wt % (e.g., 5 wt % to 15 wt %) of the plurality of silicon-based nanostructures attached to the carbon-based substrate.

In certain embodiments, the polymer comprising monomeric units formed from styrene and allyl alcohol (e.g. PSAA) may be provided as an outer coating layer (partial or complete) on the plurality of silicon-based nanostructures and the carbon-based substrate. In such embodiments, the plurality of silicon-based nanostructures and the carbon-based substrate may further comprise a conductive carbon coating provided as an inner coating layer. The inner coating layer is located between the plurality of silicon-based nanostructures and the carbon-based substrate and the outer coating layer. The conductive carbon coating may be formed by carbonizing (e.g., at a temperature between 200° C. and 750° C.) a polymeric coating predisposed on the silicon-based nanostructures and carbon-based substrate, wherein said polymeric coating may be a polymer comprising monomeric units formed from styrene and allyl alcohol (e.g. PSAA).

In some embodiments, the composite comprises a population of silicon-based nanostructures and carbon-based substrates having the polymer comprising monomeric units formed from styrene and allyl alcohol disposed directly thereon and a population of silicon-based nanostructures and carbon-based substrates having the polymer comprising monomeric units formed from styrene and allyl alcohol disposed indirectly thereon via an intervening conductive carbon coating.

The composite may further comprise a conductive additive. Conductive additives useful in the preparation of battery anode materials will be familiar to one of skill in the art, and include carbon black particles, carbon nanofibers, carbon nanotubes, graphite particles, graphene particles, mesocarbon microbead particles and combinations of two or more thereof. As used herein, “carbon black” refers to the material produced by the incomplete combustion of petroleum products. Carbon black is a form of amorphous carbon that has an extremely high surface area to volume ratio. “Graphene” refers to a single atomic layer of carbon formed as a sheet and can be prepared as graphene powders. Reference is made to U.S. Pat. Nos. 5,677,082, 6,303,266 and 6,479,030, the disclosures of each of which are incorporated by reference herein in their entireties. A particularly suitable conductive additive is carbon black. When a conductive additive is present, it may be disposed on, or dispersed throughout, the polymer comprising monomeric units formed from styrene and allyl alcohol (e.g., PSAA). In some embodiments, the use of a conductive carbon coating formed from carbonized PSAA may eliminate the need for an additional conductive additive.

The composite is suitably provided as a plurality of particles. The exact form of the composite will depend on the nature of the silicon-based nanostructures and the carbon-based substrate. For example, the composite may be provided as a powder (e.g. a free-flowing powder). The presence of the polymer comprising monomeric units formed from styrene and allyl alcohol on the outer surface of the silicon-based nanostructures and the carbon-based substrate leads to little, if any, agglomeration between individual composite particles at room temperature or at temperatures below the softening temperature of the polymer.

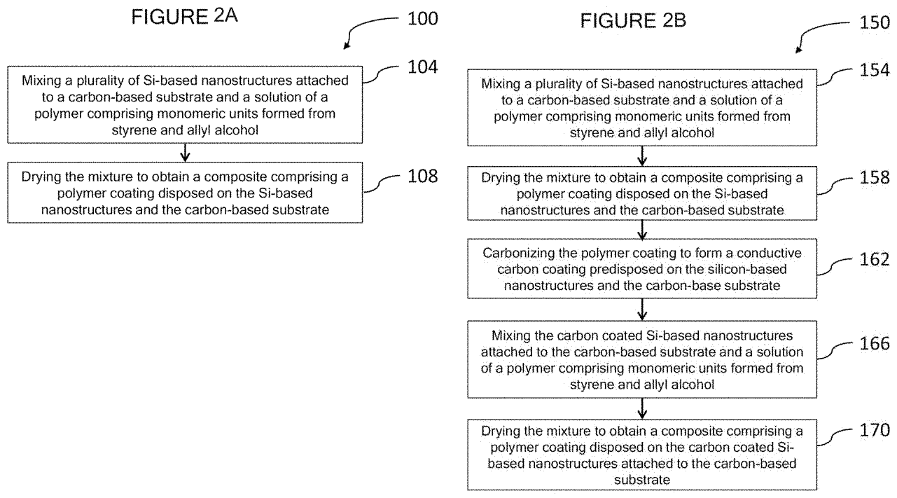

In a second aspect, embodiments provide a process for preparing a composite. The process is illustrated for example in FIG. 2A. As shown in FIG. 2A, the process (100) comprises mixing a plurality of silicon-based nanostructures attached to a carbon-based substrate (104), and a solution of a polymer to form a mixture, the polymer comprising monomeric units formed from styrene and allyl alcohol; and drying the mixture (108).

It will be understood that those features of the second aspect that are also described hereinbefore in relation to the first aspect may have any of those aforementioned definitions.

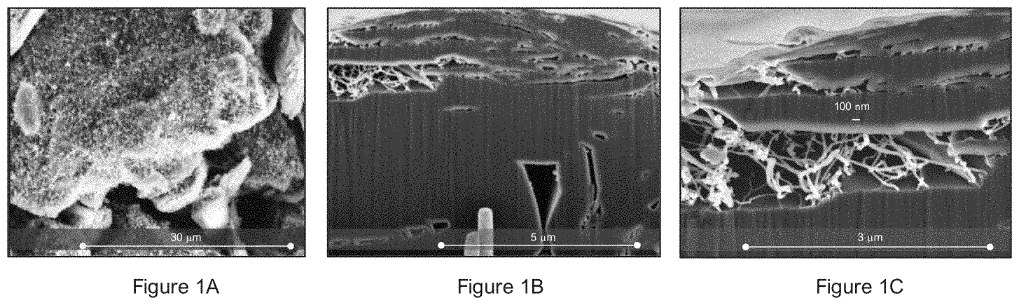

The silicon-based nanostructures attached to the carbon-based substrate may be prepared by growing the silicon-based nanostructures (e.g., silicon nanowires) from catalyst particles deposited on surfaces of carbon-based substrates via a VLS or VSS chemical vapor deposition technique. In some embodiments, the carbon-based substrate is a graphite powder (e.g., natural graphite powder or artificial graphite powder) comprising a plurality of graphite particles, each comprising a plurality of pores, wherein silicon-based nanostructures (e.g., silicon nanowires) are grown by a VLS or VSS chemical vapor deposition technique from catalyst particles (e.g., catalyst nanoparticles comprising copper, a copper compound and/or a copper alloy) deposited on external and internal surfaces (i.e., those defining pores) of the graphite particles, thereby affording silicon-based nanostructures attached to external and internal surfaces of the graphite particles. FIGS. 1A to 10 shows SEM pictures of uncoated natural graphite particles comprising silicon-based nanowires attached to surfaces of the graphite particles, including silicon nanowires attached to the internal surfaces (i.e., those surfaces defining pore) of the graphite particles.

The solution of the polymer (e.g., PSAA) may comprise the polymer and ethanol. In contrast to the use of water-soluble polymers, polymers that are soluble in ethanol can be straightforwardly dried at lower temperatures and/or under pressure lower than atmospheric pressures, without leaving any solvent residues on the silicon-based nanostructures, which can negatively impact battery performance. Ethanol removed during the drying can be recovered and recycled into the process. Suitably, the solution comprises <5 wt % water. More suitably, the solution is free from water.

The solution of the polymer may comprise 0.05 wt % to 10 wt % of the polymer (e.g., 0.05 wt % to 10 wt % of the polymer in ethanol). Suitably, the solution comprises 0.1 wt % to 3 wt % of the polymer.

The drying may be conducted at a temperature in the range from 20° C. to 150° C., at ambient or reduced pressure (e.g., under vacuum). Suitably, the drying is conducted at a temperature of 30° C. to 130° C. Step (b) may be conducted under an inert gas (e.g., nitrogen).

In another aspect, embodiments provide a process for preparing a composite, as illustrated for example in FIG. 2B. As shown in FIG. 2B, the process (150) comprises mixing a plurality of silicon-based nanostructures attached to a carbon-based substrate (154), and a solution of a polymer to form a mixture, the polymer comprising monomeric units formed from styrene and allyl alcohol; and drying the mixture (158).

In embodiments, the plurality of silicon-based nanostructures and carbon-based substrate have a conductive carbon coating disposed thereon. The coating may be partial or complete. The conductive carbon coating may be formed by carbonizing a polymeric coating predisposed on the plurality of silicon-based nanostructures and carbon-based substrate (162), as shown in FIG. 2B. The polymeric coating may comprise monomeric units formed from styrene and allyl alcohol (e.g. PSAA). The polymeric coating may be predisposed on the plurality of silicon-based nanostructures and carbon-based substrate by mixing the plurality of silicon-based nanostructures and carbon-based substrate with a solution of a polymeric material (e.g. a solution of PSAA in ethanol, such as a 5-10 wt % solution of PSAA in ethanol). The polymeric material predisposed on the plurality of silicon-based nanostructures and carbon-based substrate is then carbonized by heating the plurality of silicon-based nanostructures and carbon-based substrate having the polymeric material disposed thereon to a temperature of 200° C. to 750° C. (e.g. 500° C. to 750° C.), optimally in an inert atmosphere (e.g. under nitrogen). Therefore, in some embodiments, the composite resulting from drying may comprise PSAA disposed on a carbonised PSAA coating layer that is provided on the silicon-based nanostructure and carbon-based substrate.

The composite resulting from the drying is suitably a powder (e.g. a free-flowing powder). The use of a polymer comprising monomeric units formed from styrene and allyl alcohol (particularly PSAA) leads to little to no agglomeration between composite particles.

As shown in FIG. 2B, the process (150) may further include mixing the carbon coated Si-based nanostructures attached to the carbon-based substrate and a solution of a polymer comprising monomeric units formed from styrene and allyl alcohol (166) and drying the mixture to obtain a composite comprising a polymer coating disposed on the carbon coated Si-based nanostructures attached to the carbon-based substrate (170).

In a third aspect, embodiments provide a composite obtained, directly obtained or obtainable by the process of the second aspect.

### Anode Electrodes and Preparation Thereof

In a fourth aspect, embodiments provide an anode electrode comprising a first anodic layer, the first anodic layer comprising a binder and a composite as described herein.

The anode electrodes described herein, which comprise a polymer comprising monomeric moieties formed from styrene and allyl alcohol disposed on silicon-based nanostructures attached to a carbon-based substrate, possess those advantageous properties discussed hereinbefore, including improved uniformity, ease of processing according to wet or dry electrode coating techniques, improved ability to accommodate volume changes and superior adhesion to other anodic components, including the current collector and any additional anodic layers. Accordingly, batteries incorporating the anode electrodes of the invention offer improved electronic properties (e.g. specific capacity and/or initial coulombic efficiency (ICE)).

It will be understood that those features of the fourth aspect that are also described hereinbefore in relation to the first, second or third aspects may have any of those aforementioned definitions.

The first anodic layer comprises a binder and a composite of the first aspect, suitably in an intimate and substantially homogenous mixture. Any suitable binder may be used in the first anodic layer. Suitably, the binder is selected from the group consisting of styrene butadiene rubber (SBR), carboxymethyl cellulose (CMC), poly(vinylidene fluoride) (PVDF), poly(acrylic acid) (PAA), poly(acrylonitrile) (PAN), poly(acrylamide-co-diallyldimethylammonium) (PAADAA), poly(tetrafluoroethylene) (PTFE), and a combination of two or more thereof. In particular embodiments, the binder is a mixture of styrene butadiene rubber and carboxymethyl cellulose. For example, the binder may be a mixture of styrene butadiene rubber and carboxymethyl cellulose comprising 30 wt % to 70 wt % of styrene butadiene rubber and 30 wt % to 70 wt % of carboxymethyl cellulose, more suitably 40 wt % to 60 wt % of styrene butadiene rubber and 40 wt % to 60 wt % of carboxymethyl cellulose). In other embodiments, the binder is poly(tetrafluoroethylene), which is particularly useful when the first anodic layer has been prepared by a dry coating technique.

The first anodic layer may additionally comprise a conductive additive, suitably in an amount of 0.2 wt % to 5 wt %. Suitable conductive additives are described hereinbefore. A particularly suitable conductive additive is carbon black. The conductive additive may be dispersed throughout the binder, and/or the composite, binder and conductive additive may form an intimate and substantially homogenous mixture within the first anodic layer. A polymer comprising monomeric units formed from styrene and allyl alcohol (e.g., PSAA) may be disposed on the conductive additive.

The first anodic layer suitably comprises 90 wt % of the composite. As described hereinbefore, the plurality of silicon-based nanostructures attached to a carbon-based substrate present in the composite may comprise 1 wt % to 40 wt % silicon. Also described hereinbefore, the composite may comprise 0.1 wt % to 10 wt % of the polymer comprising monomeric units formed from styrene and allyl alcohol (e.g., PSAA).

The presence of the polymer comprising monomeric units formed from styrene and allyl alcohol in the composites of the first aspect permit the preparation of anode electrodes having reduced quantities of binder, such that the anode electrodes have a low ratio of inactive to active materials. For example, the first anodic layer may comprise 0.5 wt % to 10 wt % of the binder. Suitably, the first anodic layer comprises 1 wt % to 6 wt % of the binder.

The first anodic layer may comprise 0.5 wt % to 10 wt % of the binder and 90 wt % to 99.5 wt % of the composite. Suitably, the first anodic layer comprises 1 wt % to 6 wt % of the binder and 94 wt % to 99 wt % of the composite. Within the composite, the plurality of silicon-based nanostructures attached to a carbon-based substrate may comprise 1 wt % to 40 wt % silicon. The composite may comprise 0.1 wt % to 10 wt % of the polymer comprising monomeric units formed from styrene and allyl alcohol (e.g., PSAA).

In some embodiments, the first anodic layer comprises 0.5 wt % to 10 wt % of the binder and 90 wt % to 99.5 wt % of the composite, wherein the composite comprises 0.1 wt % to 10 wt % (e.g., 0.5 wt % to 5 wt %) of the polymer comprising monomeric units formed from styrene and allyl alcohol (e.g., PSAA). Suitably, the binder is a mixture of styrene butadiene rubber and carboxymethyl cellulose (e.g., 30 wt % to 70 wt % of styrene butadiene rubber and 30 wt % to 70 wt % of carboxymethyl cellulose). The first anodic layer may further comprise 0.2 wt % to 5 wt % of a conductive additive (e.g., carbon black).

In some embodiments, the first anodic layer comprises 1 wt % to 6 wt % of the binder and 94 wt % to 99 wt % of the composite, wherein the composite may comprise 0.1 wt % to 10 wt % (e.g. 0.5 wt % to 3 wt %) of the polymer comprising monomeric units formed from styrene and allyl alcohol (e.g. PSAA). Suitably, the binder is a mixture of carboxymethyl cellulose and styrene butadiene rubber (e.g. 40 wt % to 60 wt % of styrene butadiene rubber and 40 wt % to 60 wt % of carboxymethyl cellulose). The first anodic layer may further comprise 0.2 wt % to 5 wt % of a conductive additive (e.g. carbon black).

The anode electrode may be a single-layer anode electrode, such that the first anodic layer is the sole anodic layer.

Alternatively, the anode electrode may be a multi-layer anode electrode, such that it comprises one or more additional anodic layers. Each additional anodic layer may independently comprise an active material and a binder, suitably in an intimate and substantially homogenous mixture. Any one or more of the aforementioned binders may be used. The active material may be selected from the group consisting of a graphite powder, a plurality of silicon-based nanostructures attached to a carbon-based substrate, a composite of the first aspect, and a combination of two or more thereof. Each additional anodic layer may optionally comprise one or more conductive additives described herein. The multi-layer anode electrode may be described as a stack of anodic layers (e.g., the first anodic layer and one or more additional anodic layers). In a multi-layer anode, one or more of the anodic layers may comprise different carbon-based substrates and different amount of silicon-based nanostructures attached to the carbon-based substrates. Each of the layers may also comprise carbon-based substrates with varying D₅₀. Each of the layers may also have different porosity. A polymer comprising monomeric units formed from styrene and allyl alcohol (e.g. PSAA) may be applied to the silicon-based nanostructures and carbon-based substrates in all of the layers or only in some of the layers.

The anode electrode may further comprise a current collector. Any suitable current collector may be used in the anode electrodes of the invention. Suitably, the current collector is a copper foil or a carbon-coated copper foil.

The first anodic layer, and any additional anodic layers, is/are intended to be in electrical communication with a current collector, such that current can flow from the electrolyte to a current collector. A current collector may form part of the anode electrode.

In certain embodiments, the first anodic layer comprises a first surface configured to contact (or being in contact with) a current collector, and a second surface in contact with one or more additional anodic layers. The second surface of the first anodic layer may comprise metallic lithium disposed thereon. The metallic lithium may be selected from lithium metal foil, stabilized lithium metal powder, and a combination thereof.

In other embodiments, the anode electrode comprises one or more additional anodic layers described herein positioned between the first anodic layer and a current collector.

The first anodic layer, and any additional anodic layers may be substantially free (e.g. free) of solvent residues and/or may each be provided as a free-standing film. Such anodic layers can be formed, e.g., by a dry coating technique (e.g., by extrusion and/or calendaring). In embodiments, the anode electrode is a multi-layer anode electrode, wherein all anodic layers are substantially free (e.g. free) of solvent residues (e.g. have been formed by a dry coating technique).

The polymer comprising monomeric units formed from styrene and allyl alcohol (e.g. PSAA) present in the composite displays favourable interactions with binders typically used in the formation of anodic layers according to a dry coating technique (e.g. poly(tetrafluoroethylene)). At room temperature, the composite comprising the polymer (e.g. PSAA) is typically provided as a powder, in which there is little to no agglomeration of particles. The composite (e.g. composite powder) can be straightforwardly mixed with a binder to provide an intimate and substantially homogenous powder, in which there is little to no agglomeration. A modest increase in temperature (e.g., to 50° C. to 200° C., or 60° C. to 180° C.) softens the polymer (e.g. PSAA) of the composite and facilitates adhesion to the binder particles, allowing a dry anodic layer to formed (e.g. extruded and/or calendared) into a film, such as a free-standing film.

In embodiments, the binder of the first anodic layer is poly(tetrafluoroethylene), wherein the first anodic layer is substantially free (e.g., free) of solvent residues. The anode electrode may be a single-layer anode electrode. Alternatively, the anode electrode may be a multi-layer anode electrode, wherein one or more additional anodic layers also comprises poly(tetrafluoroethylene) as a binder. The multi-layer anode electrode may be such that all anodic layers are substantially free (e.g., free) of solvent residues.

The first anodic layer, and any additional anodic layers, may have a density of 1 g cm⁻³ to 1.7 g cm⁻³. Suitably, the first anodic layer, and any additional anodic layers, may have a density of 1.3 g cm⁻³ to 1.5 g cm⁻³.

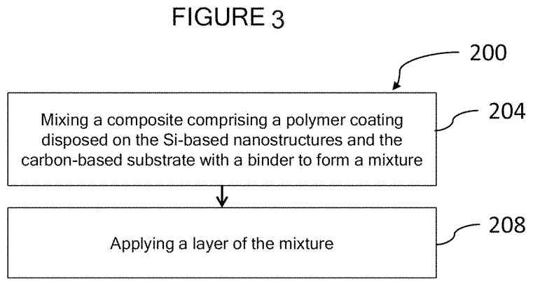

In a fifth aspect, embodiments provide a process for preparing an anode electrode (200), as shown in FIG. 3. The process of FIG. 3 comprises mixing: a composite as described herein and a binder to form a mixture (204); and applying a layer of the mixture (208).

It will be understood that those features of the fifth aspect that are also described hereinbefore in relation to the first, second, third or fourth aspects may have any of those aforementioned definitions. For example, it will be understood that the composite of the fifth aspect may first be prepared according to the steps outlined in the second aspect.

The components mixed during the mixing may further include a conductive additive. Suitable conductive additives are described hereinbefore. A particularly suitable conductive additive is carbon black. A polymer comprising monomeric units formed from styrene and allyl alcohol (e.g. PSAA) may be disposed on the conductive additive. The amount of the conductive additive may be 0.2 wt % to 5 wt % relative to the mass of the composite and (dry) binder.

The layer that is applied is configured to be in contact with a current collector. For example, the applying the layer of the mixture may comprise applying a layer of the mixture such that it is in electrical communication with a current collector.

In certain embodiments, the mixture is provided as a wet slurry and the process further comprises drying the applied layer. For example, the binder may be provided as a solution (e.g., an aqueous solution). The dried layer may then be calendared onto a current collector.

In other embodiments, the mixture is provided as a solid. In such embodiments, the applying the layer may comprise forming (e.g. by extruding and/or calendaring) a layer (e.g. a film) of the solid mixture. Prior to forming, the solid mixture may be heated to a temperature of 50° C. to 200° C. (e.g., 60° C. to 180° C.), which may promote adhesion of the composite and binder, thereby yielding a more uniform layer. The formed (e.g., extruded and/or calendared) layer may be a free-standing film, which is optionally free of solvent residues. The formed (e.g., extruded and/or calendared) layer (e.g., free-standing film) may then be laminated onto a current collector.

The applying the layer of the mixture may comprise applying the layer of the mixture onto a current collector. The anode electrode may be a single-layer anode electrode, such that the applied layer is the sole anodic layer. Alternatively, the anode electrode may be a multi-layer anode electrode, such that the process further comprises a step of applying one or more additional anodic layers onto the applied layer, wherein the one or more additional anodic layers independently comprise an active material and a binder. The application of the one or more additional anodic layers onto the layer may be described as forming a stack of anodic layers.

In an additional aspect, embodiments provide a process for preparing an anode electrode, the process comprising: mixing: a plurality of silicon-based nanostructures attached to a carbon-based substrate, a polymer comprising monomeric units formed from styrene and allyl alcohol, and a binder to form a mixture; applying a layer of the mixture.

It will be understood that those features of this additional aspect that are also described hereinbefore in relation to the first, second, third, fourth or fifth aspects may have any of those aforementioned definitions.

In a sixth aspect, embodiments provide an anode electrode obtained, directly obtained or obtainable by any process for preparing an anode electrode described hereinbefore.

### Batteries

In a seventh aspect, embodiments provide a battery comprising a composite and/or an anode electrode as described herein.

The batteries, the anodes of which comprise a polymer comprising monomeric moieties formed from styrene and allyl alcohol disposed on silicon-based nanostructures attached to a carbon-based substrate, possess those advantageous properties discussed hereinbefore, including improved anode uniformity, improved ability to accommodate volume changes and superior integrity of the anodic components. Accordingly, the batteries described herein offer improved electronic properties (e.g., specific capacity and/or initial coulombic efficiency (ICE)).

Most suitably, the battery is a lithium-ion battery.

### Numbered Statements

The following numbered statements 1-64 are not claims, but instead describe particular aspects and embodiments.
1. A composite comprising a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol.
2. The composite of statement 1, wherein the polymer has a softening point of less than 200° C.
3. The composite of statement 1 or 2, wherein the polymer is insoluble in water.
4. The composite of statement 1, 2 or 3, wherein the polymer is soluble in alcohol (e.g., ethanol).
5. The composite of any one of the preceding statements, wherein the polymer is poly(styrene-co-allyl alcohol).
6. The composite of any one of the preceding statements, wherein the polymer comprises at least 25 mol % of monomeric units formed from allyl alcohol.
7. The composite of any one of the preceding statements, wherein the composite comprises 0.1 wt % to 10 wt % of the polymer.
8. The composite of any one of the preceding statements, wherein the composite comprises 0.5 wt % to 5 wt % of the polymer.
9. The composite of any one of the preceding statements, wherein the plurality of silicon-based nanostructures are silicon nanowires, silicon nanoparticles or a combination thereof.
10. The composite of any one of the preceding statements, wherein the plurality of silicon-based nanostructures are silicon nanowires
11. The composite of statement 10, wherein the silicon nanowires have diameters in the range of 10 nm to 200 nm.
12. The composite of any one of the preceding statements, wherein the plurality of silicon-based nanostructures comprise a monocrystalline core and a shell layer, wherein the shell layer comprises amorphous silicon, polycrystalline silicon, or a combination thereof.
13. The composite of any one of the preceding statements, wherein the composite comprises 90 wt % of the silicon-based nanostructures attached to the carbon-based substrate.
14. The composite of any one of the preceding statements, wherein the composite comprises 95 wt % of the silicon-based nanostructures attached to the carbon-based substrate.
15. The composite of any one of the preceding statements, wherein the carbon-based substrate is a carbon-based powder.
16. The composite of statement 15, wherein the carbon-based powder has a D₅₀ of 5 μm to 50 μm.
17. The composite of any one of the preceding statements, wherein the carbon-based substrate is selected from the group consisting of graphite powder, mesocarbon microbead powder or a combination thereof.
18. The composite of any one of the preceding statements, wherein the carbon-based substrate is graphite powder.
19. The composite of any one of the preceding statements, wherein the carbon-based substrate is graphite powder, the graphite powder comprising a plurality of graphite particles, each particle comprising a plurality of pores disposed therein, wherein the silicon-based nanostructures are attached to surfaces defining said pores.
20. The composite of any one of the preceding claims, wherein the carbon-based substrate is graphite powder comprising uncoated, natural graphite particles.
21. The composite of any one of the preceding statements, wherein the plurality of silicon-based nanostructures attached to a carbon-based substrate comprise 1 wt % to 40 wt % silicon.
22. The composite of any one of the preceding statements, wherein the plurality of silicon-based nanostructures attached to a carbon-based substrate comprises 2.5 wt % to 25 wt % silicon (e.g. 5 wt % to 15 wt % silicon).
23. The composite of any one of the preceding statements, wherein the plurality of silicon-based nanostructures and the carbon-based substrate further comprise a conductive carbon coating (e.g. carbonized PSAA), wherein the polymer comprising monomeric units formed from styrene and allyl alcohol (e.g., PSAA) is disposed on the conductive carbon coating.
24. The composite of statement 23, wherein the conductive carbon coating (e.g., carbonized PSAA) is provided as an inner coating layer on the plurality of silicon-based nanostructures and the carbon-based substrate, and the polymer comprising monomeric units formed from styrene and allyl alcohol (e.g., PSAA) is provided as an outer coating layer on the plurality of silicon-based nanostructures and the carbon-based substrate.
25. A process for preparing a composite, the process comprising:
   mixing:
      a plurality of silicon-based nanostructures attached to a carbon-based substrate, and
      a solution of a polymer, the polymer comprising monomeric units formed from styrene and allyl alcohol to for a mixture; and drying the mixture.
26. The process of statement 25, wherein the solution of the polymer comprises the polymer and an alcoholic solvent (e.g. ethanol).
27. The process of statement 25 or 26, wherein the solution of the polymer does not comprise water.
28. The process of statement 25, 26 or 27, wherein the solution comprises 0.05 wt % to 10 wt % of the polymer.
29. The process of any one of statements 25 to 28, wherein the solution comprises 0.1 wt % to 3 wt % of the polymer (e.g. 0.5 wt % to 1.5 wt %).
30. The process of any one of statements 25 to 29, wherein the drying is conducted at a temperature of 20° C. to 150° C., at ambient or reduced pressure (e.g. under vacuum).
31. The process of any one of statements 25 to 30, wherein the drying is conducted at a temperature of 30° C. to 130° C., optionally under an inert gas (e.g. nitrogen).
32. The process of any one of statements 25 to 31, wherein the plurality of silicon-based nanostructures attached to a carbon-based substrate comprise a conductive carbon coating.
33. The process of statement 32, wherein the conductive carbon coating is formed by carbonizing a polymeric coating predisposed on the silicon-based nanostructures and the carbon-based substrate.
34. The process of statement 33, wherein the polymeric coating predisposed on the silicon-based nanostructures and the carbon-based substrate is a polymer comprising monomeric units formed from styrene and allyl alcohol.
35. The process of statement 33 or 34, where carbonizing the polymeric coating predisposed on the silicon-based nanostructures and the carbon-based substrate comprises heating the silicon-based nanostructures and the carbon-based substrate having the polymeric coating predisposed thereon at a temperature of 200° C. to 750° C. (e.g. 500° C. to 750° C.), optionally in an inert atmosphere (e.g. under nitrogen).
36. An anode electrode comprising a first anodic layer, the first anodic layer comprising a binder and a composite as in any one of statements 1 to 24.
37. The anode electrode of statement 36, wherein the binder is selected from the group consisting of styrene butadiene rubber (SBR), carboxymethyl cellulose (CMC), poly(vinylidene fluoride) (PVDF), poly(acrylic acid) (PAA), poly(acrylonitrile) (PAN), poly(acrylamide-co-diallyldimethylammonium) (PAADAA), poly(tetrafluoroethylene) (PTFE), and a combination of two or more thereof.
38. The anode electrode of statement 36 or 37, wherein the binder is a mixture of styrene butadiene rubber (SBR) and carboxymethyl cellulose (CMC).
39. The anode electrode of statement 38, wherein the binder comprises 30 wt % to 70 wt % of butadiene rubber (SBR) and 30 wt % to 70 wt % of carboxymethyl cellulose (CMC).
40. The anode electrode of statement 36 or 37, wherein the binder is poly(tetrafluoroethylene) (PTFE).
41. The anode electrode of any one of statements 36 to 40, wherein the first anodic layer comprises 0.5 wt % to 10 wt % of the binder.
42. The anode electrode of any one of statements 36 to 41, wherein the first anodic layer comprises 1 wt % to 6 wt % of the binder.
43. The anode electrode of any one of statements 36 to 42, wherein the first anodic layer comprises 90 wt % of the composite.
44. The anode electrode of any one of statements 36 to 43, wherein the first anodic layer further comprises a conductive additive.
45. The anode electrode of statement 44, wherein first anodic layer comprises 0.2 wt % to 5 wt % of the conductive additive.
46. The anode electrode of statement 44 or 45, wherein the conductive additive is selected from the group consisting of carbon black particles, carbon nanofibers, carbon nanotubes, and a combination of two or more thereof.
47. The anode electrode of any one of statements 36 to 46 wherein the anode electrode further comprises a current collector.
48. The anode electrode of statement 47, wherein the current collector is a copper foil or a carbon-coated copper foil.
49. The anode electrode of any one of statements 36 to 48, further comprising one or more additional anodic layers, each additional anodic layer independently comprising an active material and a binder.
50. The anode electrode of statement 49, wherein the first anodic layer comprises a first surface configured to contact (or being in contact with) a current collector, and a second surface in contact with the one or more additional anodic layers.
51. The anode electrode of statement 50, wherein the second surface of the first anodic layer comprises metallic lithium disposed thereon.
52. The anode electrode of statement 51, wherein the metallic lithium is selected from lithium metal foil, stabilized lithium metal powder, and a combination thereof.
53. The anode electrode of any one of statements 49 to 52, wherein the active material is selected from the group consisting of a graphite powder, a plurality of silicon-based nanostructures attached to a carbon-based substrate, a composite as in any one of statements 1 to 24, and a combination of two or more thereof.
54. The anode electrode of statement 53, wherein at least one of the one or more additional anodic layers further comprise a conductive additive, wherein the conductive additive is selected from the group consisting of carbon black particles, carbon nanofibers, carbon nanotubes, and a combination of two or more thereof.
55. A process for preparing an anode electrode, the process comprising:
   mixing:
      a composite as in any one of statements 1 to 24, and
      a binder to form a mixture; and
   applying a layer of the mixture.
56. The process of statement 55, wherein the layer is configured to be in contact with a current collector.
57. The process of statement 55 or 56, wherein the mixture is provided as a wet slurry and the process further comprises drying the layer.
58. The process of statement 55 or 56, wherein the mixture is provided as a solid and the applying comprises forming a layer of the solid mixture.
59. The process of any one of statements 55 to 58, wherein the applying comprises applying a layer of the mixture onto a current collector.
60. The process of statement 59, further comprising applying one or more additional anodic layers onto the layer, wherein the one or more additional anodic layers each independently comprise an active material and a binder.
61. The process of statement 60, wherein the active material is selected from the group consisting of a graphite powder, a plurality of silicon-based nanostructures attached to a carbon-based substrate, a composite as in any one of statements 1 to 24, and a combination of two or more thereof.
62. The process of statement 61, wherein at least one of the one or more additional anodic layers further comprise a conductive additive, wherein the conductive additive is selected from the group consisting of carbon black particles, carbon nanofibers, carbon nanotubes, and a combination of two or more thereof.
63. A battery comprising: a composite as in any one of statements 1 to 24 and/or an anode electrode as in any one of statements 36 to 54.
64. The battery of statement 63 wherein the battery is a lithium ion battery.

### EXAMPLES

One or more examples of the invention will now be described, for the purpose of illustration only, with reference to the accompanying figures:

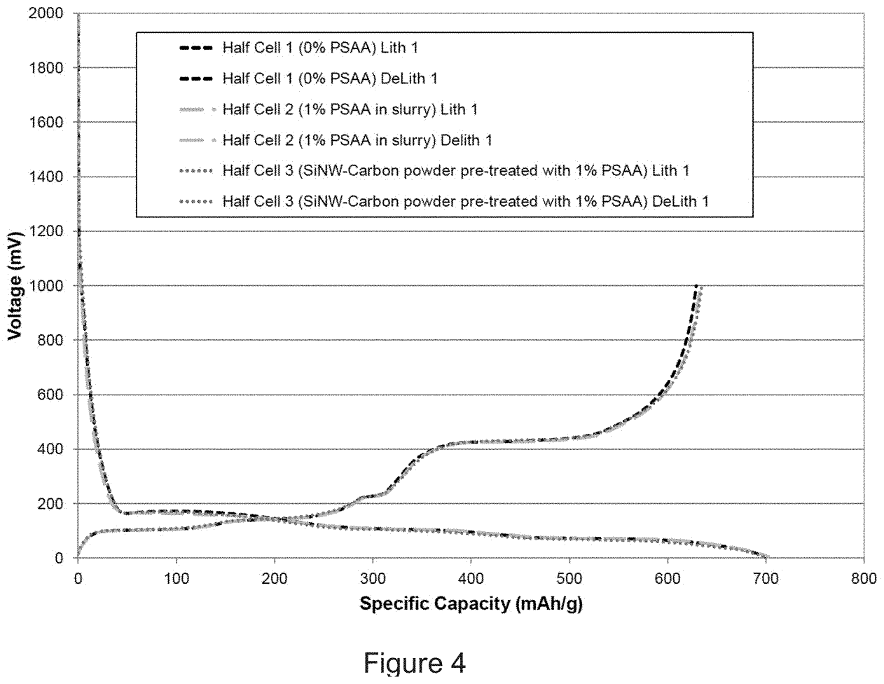

FIG. 4 shows the performance of Half Cells 1-3 described in Example 2.

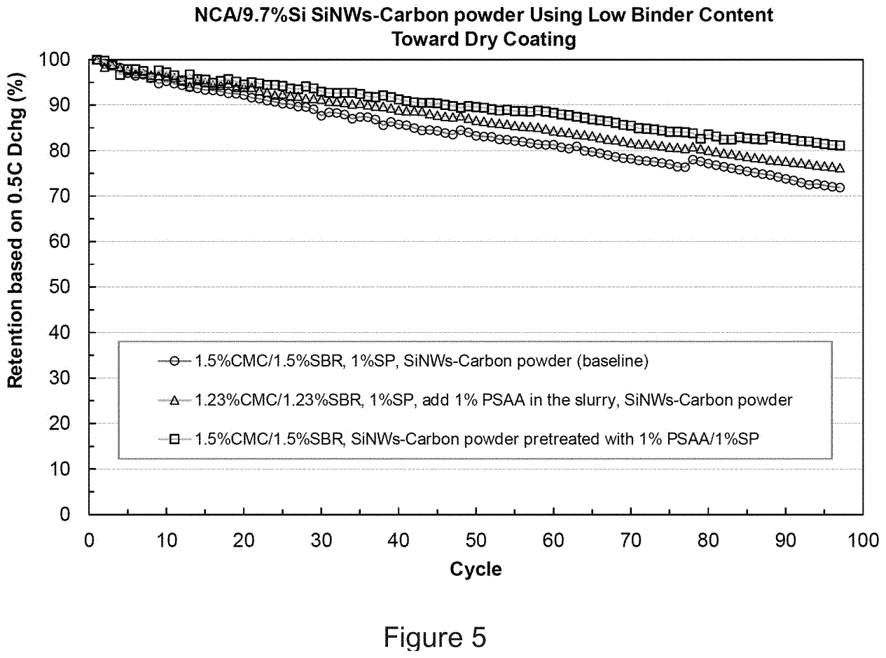

FIG. 5 shows the cycling performance of the three anodes described in Example 2.

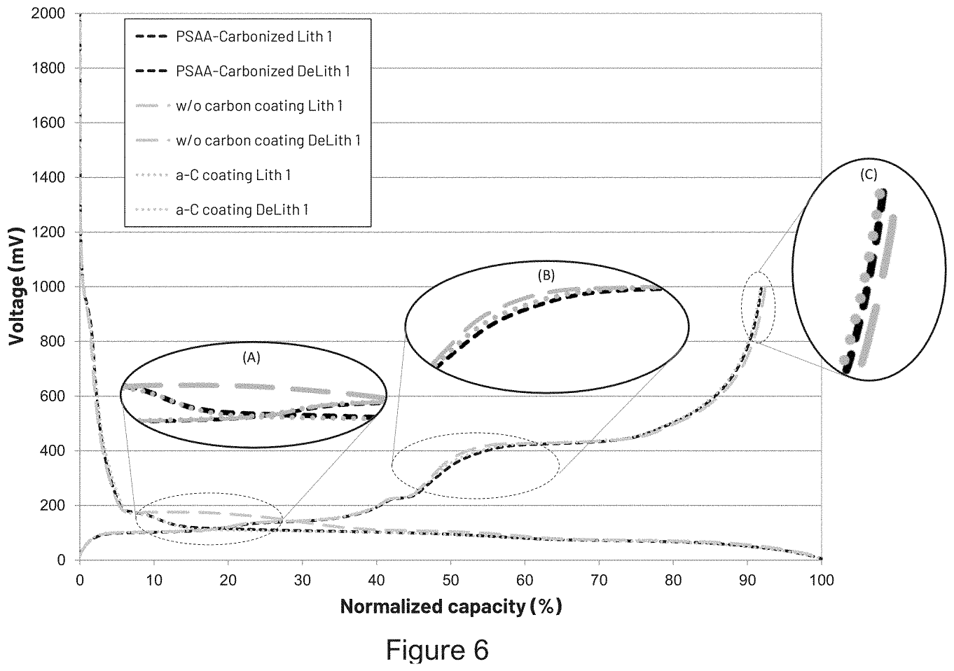

FIG. 6 shows the performance of Half Cells 1-3 described in Example 2.

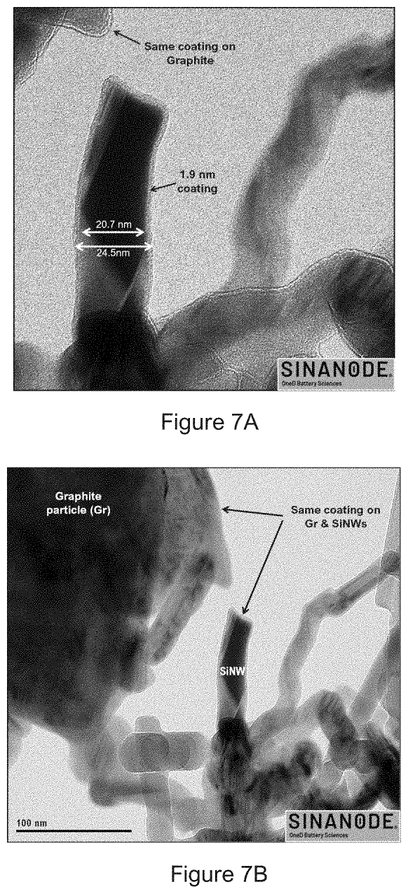

FIGS. 7A and 7B show SEM pictures with high magnification of SiNWs-Carbon powder after the PSAA carbonization in Example 3, showing the thin coating layer onto both the silicon and the graphite surfaces.

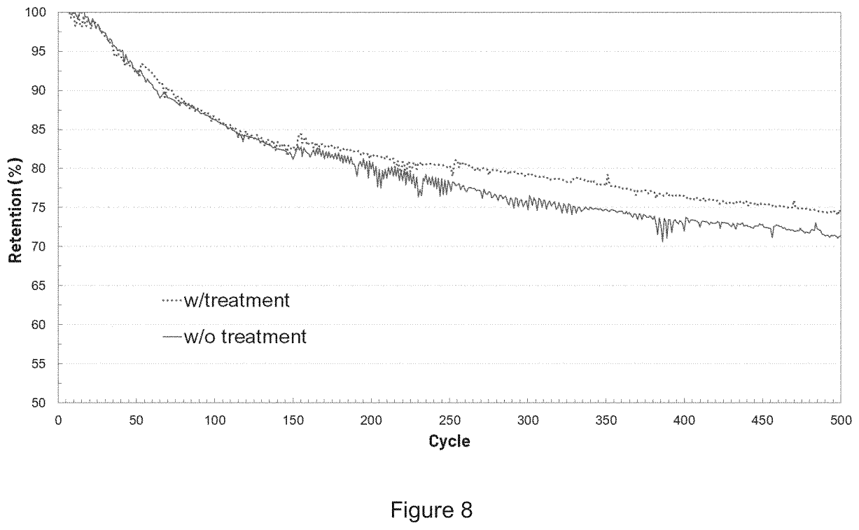

FIG. 8 shows the performance of two NCA pouch cells described in Example 4.

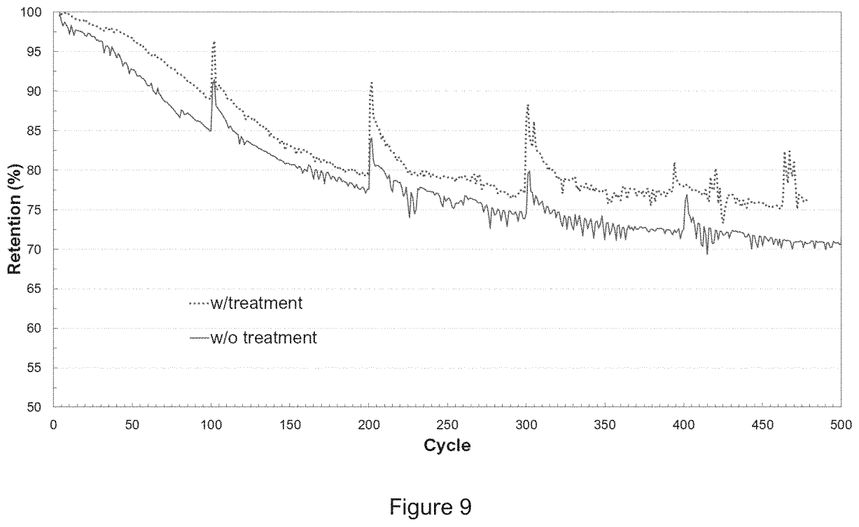

FIG. 9 shows the performance of two NCA pouch cells described in Example 5.

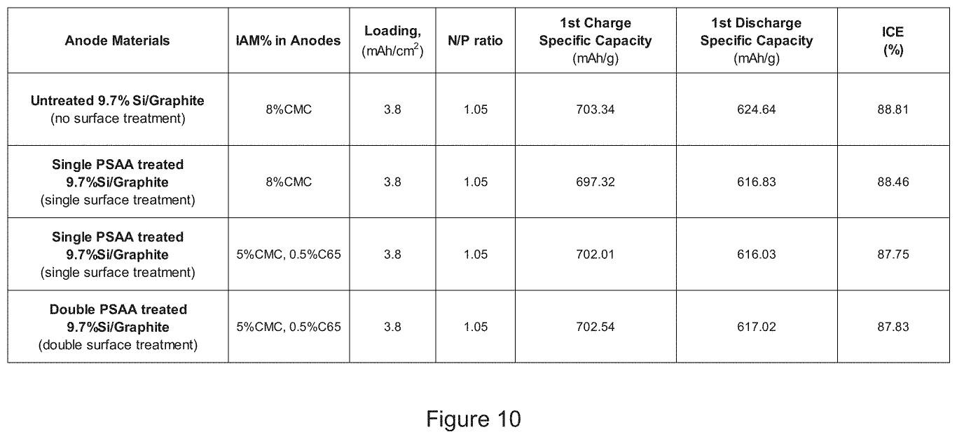

FIG. 10 shows the specifications, 1st charge capacity, and 1st discharge capacity of four (4) sets of electrochemical comprising anode material composites comprising different combination of SiNW-carbon and PSAA.

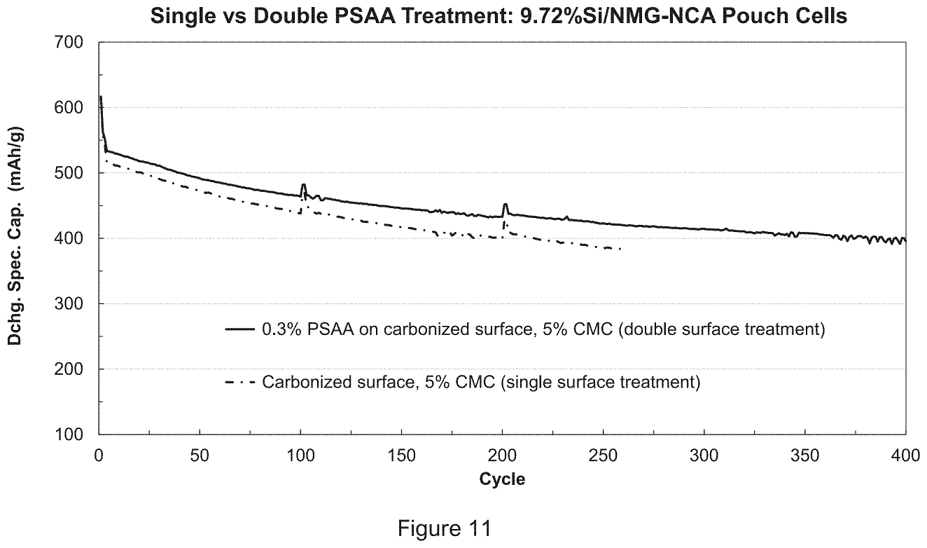

FIG. 11 shows discharge specific capacity over hundreds of cycles for two types of electrochemical cells, the first type comprising an anode composite prepared using a single surface treatment and the second type comprising an anode composite prepared using a double surface treatment.

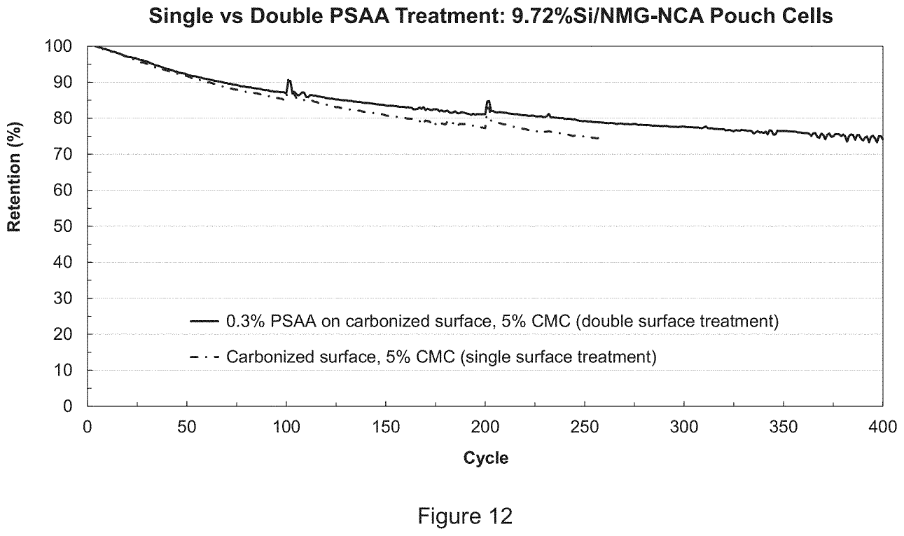

FIG. 12 shows % capacity retention over hundreds of cycles for two types of electrochemical cells, the first type comprising an anode composite prepared using a single surface treatment and the second type comprising an anode composite prepared using a double surface treatment.

### Example 1—Preparation of Composite

The following reagents were assembled:
1 kg of silicon nanowires mechanically and conductively attached to graphite particles with the Si wt % equal to 9.7% (hereinafter referred to as SiNWs-Carbon powder), the silicon nanowires having diameters in the range of 20 nm to 100 nm (as measured with FESEM) and the graphite particles consisting of commercial natural graphite with D₅₀=14 microns. The silicon nanowires were grown onto the graphite particles using decomposition of silane gas precursor in a CVD reactor, thanks to copper (I) oxide nano-particle catalysts disposed onto the graphite particles, as described in U.S. Pat. No. 10,243,207, the entirety of which is hereby incorporated by reference.
20.2 g of 50 wt % PSAA in EtOH Solution (10.1 g of PSAA polymer content as calculated), obtained from Sigma-Aldrich, with molecular weight Mₙ˜1600.
1000 g of ethanol.

The composite was prepared as follows:
a) 1000 g ethanol was mixed with 20.2 g of 50 wt % PSAA in ethanol solution in a 5 liter stainless steel container by propelling for 5 minutes to yield 1020.2 g of diluted PSAA solution comprising ˜10.1 g of PSAA Polymer.
b) 1 kg of SiNWs-Carbon powder was immersed in the PSAA solution in the 5 liter container and mixed for 30 minutes to yield a mixture comprising SiNWs-Carbon powder with the PSAA polymer uniformly disposed thereon.
c) The mixture in the 5 liter container was placed in an oven for drying at a temperature between 40 and 120° C. under nitrogen for approximately 2 hours to yield 1010.1 g of dried composite particles. The PSAA-coated SiNWs-Carbon powder formed a powder of separate particles without any milling or sieving.

### Example 2—Half-Cell Studies

Three half cells were prepared according to the following general protocol:
a) 6.12 g of a 1.5 wt % CMC stock solution (in DI water) was gradually added to 3.97 g of DI water in a planetary kneader container and then mixed at 600 rpm for 15 minutes. The resulting mixture was kept at 30° C.
b) 5.94 g of SiNWs-Carbon powder (with or without PSAA disposed thereon) was gradually added to the mixture resulting from step a). The resulting mixture was mixed in the planetary kneader container (Non bubbling kneader, NBK-1) for 15 minutes at 400 rpm.
c) 0.23 g of a 40 wt % SBR suspension was added to the mixture resulting from step b). The resulting mixture was then mixed for 15 minutes at 400 rpm.
d) The slurry resulting from step c) was placed in a 40° C. bath for 2 minutes, and was then mixed again to achieve a slurry temperature of 30° C.
e) The slurry resulting from step d) was then used to coat an anode electrode onto a copper foil using a doctor's blade. The electrode was then dried at 90° C. for 60 minutes.
f) After 60 minutes at room temperature, the electrode resulting from step e) was then calendared to a density of 1-1.65 g cm⁻³, with a density of 1.4 g cm⁻³ being used as an example.

Half Cell 1 was used to establish a baseline performance for an anode having 1.5 wt % CMC, 1.5 wt % SBR, 1 wt % Super P® (carbon black) conductive additive, and 96 wt % of SiNWs-Carbon powder (without PSAA) containing 9.7 wt % Si. A lithium foil was used as a counter electrode. The observed 1st specific capacity for dilithiation was 629.03 mAh/g, and the observed initial coulombic efficiency (ICE) was 90.00%, as shown in FIG. 4 and Table 1 (below).

Half Cell 2: A water-based slurry was prepared by mixing 95.54 wt % SiNWs-Carbon powder (9.7 wt % Si), 1.5 wt % CMC, 1.5 wt % SBR, 1 wt % Super P® (carbon black) conductive additive, and 1 wt % PSAA (from 50 wt % PSAA in EtOH solution). The slurry was used to coat an anode electrode onto a copper foil. When 1 wt % PSAA is added into a slurry comprising 1.5 wt % CMC, 1.5 wt % SBR and 1 wt % Super P and 95.54 wt % SiNWs-Carbon powder (9.7 wt % Si), the resulting anode exhibits a 1^{st} specific capacity for dilithiation of 633.08 mAh/g and an initial coulombic efficiency (ICE) of 90.13%, as shown in FIG. 4 and Table 1 (below). The results indicate that incorporating PSAA into the anode gives rise to higher dilithiation capacity and higher ICE, relative to baseline anode Half Cell 1.

Half Cell 3: A slurry was prepared by mixing 96 wt % SiNWs-Carbon powder (9.7 wt % Si) pre-treated with 1 wt % PSAA according to the deposition process outlined in Example 1, 1.5 wt % CMC, 1.5 wt % SBR, and 1 wt % Super P® (carbon black) conductive additive. The slurry was used to coat an anode electrode onto a copper foil. When using SiNWs-carbon powder pre-treated with 1 wt % PSAA, the resulting anode shows a further increased 1st specific capacity of 634.89 mAh/g for dilithiation and further improved ICE of 90.92%, as shown in FIG. 4 and Table 1 (below). The results demonstrate that PSAA present on the SiNWs-carbon powder may lead to favourable interactions with the CMC/SBR binder. These interactions lead to a more uniform anode, which offers good access of the lithium ions to the active materials (SiNWs and graphite), thereby giving rise to improved specific capacity and ICE.

The performance of the three anode half cells is outlined in Table 1 and illustrated in FIG. 4.

TABLE 1
Performance of Half Cells 1-3

| [symbol] | [symbol] | [symbol] | IFH # [symbol] |
|---|---|---|---|
| [symbol] | [symbol] | [symbol] | [symbol] |
| [symbol] | [symbol] | [symbol] | [symbol] |
| [symbol] | [symbol] | [symbol] | [symbol] |

[symbol]

indicates data missing or illegible when filed

As shown in FIG. 4 and Table 1, the application of PSAA increases the ICE of nearly 1%. Depending on the N/P ratio of the anode and cathode specific capacities (i.e., N/P=1.05), an anode ICE that is about 1% higher results in savings of about 1% in cathode materials, which are up to five times more expensive than graphite materials, providing significant savings to EV cell makers.

The same slurry compositions were used to form three anodes that were used in their NCA pouch cells. The NCA material was purchased from BASF. The N/P ratio was 1.05. Upon completing the formation process at consequent charging/discharging at C/20 between 4.2V and 2.5V for one cycle, C/10 and C/5 between 4.2V and 3V for one cycle, respectively, three cells were cycled at C/3 charging and C/2 discharging between 4.2V and 3V, as shown in FIG. 5. The cycling performances were measured and compared as outlined in FIG. 5.

The baseline anode using 1.5 wt % CMC/1.5 wt % SBR, 1 wt % Super P, and SiNWs-Carbon powder (9.7 wt % Si) establishes the cycling performance. As shown in FIG. 5, when 1 wt % PSAA is added into the slurry, the resulting anode showed some improvement in NCA full cell cycling performance over the baseline NCA cell. Further improvement was achieved using the anode containing SiNWs-carbon powder pretreated with 1 wt % PSAA as shown in FIG. 5. The results demonstrate that pretreating SiNWs-carbon powder with PSAA can notably improve the SiNWs-carbon anode full cell performance, especially in anodes using a low content of CMC/SBR binder.

### Example 3—PSAA Carbonization Studies

The following reagents were assembled:
1 kg of silicon nanowires mechanically and conductively attached to graphite particles with the Si wt % equal to 9.7% (hereinafter referred to as SiNWs-Carbon powder), the silicon nanowires having diameters in the range of 20 nm to 100 nm (as measured with FESEM) and the graphite particles consisting of commercial natural graphite with D₅₀=14 microns. The silicon nanowires were grown onto the graphite particles using decomposition of silane gas precursor in a CVD reactor, thanks to copper (I) oxide nano-particle catalysts disposed onto the graphite particles, as described in U.S. Pat. No. 10,243,207, the entirety of which is hereby incorporated by reference.
160.0 g of 50 wt % PSAA in EtOH Solution (80.0 g of PSAA polymer content as calculated), obtained from Sigma-Aldrich, with molecular weight Mₙ˜1600.
1000 g of ethanol.

The composite was prepared as follows:
a) 1000 g ethanol was mixed with 160.0 g of 50 wt % PSAA in ethanol solution in a 5 liter stainless steel container by propelling for 5 minutes to yield 560.0 g of diluted PSAA solution comprising 80.0 g of PSAA Polymer.
b) 1 kg of SiNWs-Carbon powder was immersed in the PSAA solution in the 5 liter container and mixed for 30 minutes to yield a mixture comprising SiNWs-Carbon powder with the PSAA polymer uniformly disposed thereon.
c) The mixture in the 5 liter container was placed in an oven for drying at a temperature between 40 and 120° C. under nitrogen for approximately 2 hours to yield 1080.0 g of dried composite particles. The PSAA-coated SiNWs-Carbon powder formed a powder of separate particles without any milling or sieving.

The PSAA on the SiNWs-Carbon powder can be carbonized at 700° C. for one hour under nitrogen gas.

For comparison, an amorphous carbon coating on the same SiNWs-Carbon powder was prepared using acetylene/nitrogen (1:1) gases at 700° C. for one hour.

Three half cells were prepared according to the following general protocol:
a) 6.12 g of a 1.5 wt % CMC stock solution (in DI water) was gradually added to 3.97 g of DI water in a planetary kneader container and then mixed at 600 rpm for 15 minutes. The resulting mixture was kept at 30° C.
b) 5.94 g of SiNWs-Carbon powder (with or without PSAA disposed thereon) was gradually added to the mixture resulting from step a). The resulting mixture was mixed in the planetary kneader container (Non bubbling kneader, NBK-1) for 15 minutes at 400 rpm.
c) 0.23 g of a 40 wt % SBR suspension was added to the mixture resulting from step b). The resulting mixture was then mixed for 15 minutes at 400 rpm.
d) The slurry resulting from step c) was placed in a 40° C. bath for 2 minutes, and was then mixed again to achieve a slurry temperature of 30° C.
e) The slurry resulting from step d) was then used to coat an anode electrode onto a copper foil using a doctor's blade. The electrode was then dried at 90° C. for 60 minutes.
f) After 60 minutes at room temperature, the electrode resulting from step e) was then calendared to a density of 1-1.65 g cm⁻³, with a density of 1.4 g cm⁻³ being used as an example.

Half Cell 1 was used to establish a baseline performance for an anode having 1.5 wt % CMC, 1.5 wt % SBR, and 97 wt % of SiNWs-Carbon powder (without PSAA) containing 9.7 wt % Si. A lithium foil was used as a counter electrode. The observed 1st specific capacity for dilithiation was 648.27 mAh/g. The observed initial coulombic efficiency (ICE) was 92.41%.

Half Cell 2: A water-based slurry was prepared by mixing 97 wt % SiNWs-Carbon powder (9.7 wt % Si) with amorphous carbon coating, 1.5 wt % CMC and 1.5 wt % SBR. The slurry was used to coat an anode electrode onto a copper foil. The resulting anode exhibited a 1st specific capacity for dilithiation of 632.46 mAh/g and an initial coulombic efficiency (ICE) of 91.78%, indicating that the amorphous carbon coated SiNWs-Carbon powder anode has a slightly lower dilithiation capacity and hence a lower ICE than the uncoated SiNWs-Carbon powder anode in Half Cell 1.

Half Cell 3: A slurry was prepared by mixing 97 wt % SiNWs-Carbon powder (9.7 wt % Si) that was pre-treated with PSAA and carbonized at 700° C. under nitrogen. The binders were 1.5 wt % CMC and 1.5 wt % SBR. The slurry was used to coat an anode electrode onto a copper foil. The resulting anode showed a 1^{st} specific capacity of 638.69 mAh/g for the dilithiation and an ICE of 91.89%. Lithiation is similar to the amorphous carbon coated SiNWs-Carbon powder anode from acetylene decomposition in CVD process. However, dilithiation was better than the amorphous carbon coated SiNWs-Carbon powder anode, which resulted in higher ICE.

In FIG. 6, the X-axis is the capacity % that was normalized by the fully lithiated capacity and illustrates the lithiation curves for the three half cells of Example 3. As shown in FIG. 6, the lithiation curve for carbonized PSAA is similar to that for the thermal decomposed acetylene to amorphous carbon coating on SiNWs-carbon powders. As shown in FIG. 6A, the carbonized PSAA-coated SiNWs-carbon anode and the amorphous carbon coated SiNWs-carbon anode are equally facilitated by the carbonized layer relative to the uncoated SiNWs-carbon anode for their lithiation. As shown in FIG. 6B, dilithiation for the carbonized PSAA-coated SiNWs-carbon anode occurs at a lower potential than the amorphous carbon coated SiNWs-carbon anode and the uncoated SiNWs-carbon anode. As shown in FIG. 6C, the carbonized PSAA-coated SiNWs-carbon anode maintains a good initial coulombic efficiency. As shown in FIG. 6, the PSAA-derived carbon coating that was more uniform and easier to apply with less waste, resulted in the facilitated SiNWs' dilithiation, as compared to the more traditional method of thermal decomposition of acetylene gas.

### Example 4—Cycling of Full Electrochemical Cells (Single Sided NCA Cathode+Single Layer SiNW-Carbon Powder Anode without and with PSAA Single Surface Treatment)

The following reagents were provided:
0.0973 kg of silicon nanowires mechanically and conductively attached to uncoated natural graphite particles with the Si wt. % equal to 9.73% in 1 kg of Si—C composite (hereinafter referred to in the example as SiNWs-carbon powder), the silicon nanowires having diameters in the range of 20 nm to 100 nm (as measured with FESEM) and the graphite particles consisting of commercial uncoated natural graphite with D₅₀=14 microns. The silicon nanowires were grown onto the graphite particles using decomposition of silane gas precursor in a CVD reactor, from copper (I) oxide nano-particle catalysts disposed onto the graphite particles, as described in U.S. Pat. No. 10,243,207, the entirety of which is hereby incorporated by reference.
1000 g of 11.111 wt. % PSAA in EtOH Solution (111.11 g of PSAA polymer content as calculated), obtained from Sigma-Aldrich, with molecular weight Mₙ˜1600.
888.89 g of ethanol

The following mixtures were prepared:
a) 888.89 g of ethanol was mixed with 111.11 g of 11.111 wt. % PSAA in ethanol solution in a 5-liter stainless steel container by propelling for 5 minutes to yield 1000 g of diluted PSAA solution comprising 111.11 g of PSAA Polymer.
b) 1 kg of SiNWs-Carbon powder was immersed in the PSAA solution in the 5-liter container and mixed for 30 minutes to yield a mixture comprising SiNWs-Carbon powder with the PSAA polymer uniformly disposed thereon.
c) The mixture in the 5-liter container was placed in an oven for drying at a temperature between 40 and 120° C. under nitrogen for at least 2 hours to yield 1111.11 g of dried composite particles with 10% PSAA in the composite. The PSAA-coated SiNWs-Carbon powder formed a powder of separate particles without any milling or sieving.

Note that the PSAA content on the surface prior to the carbonization treatment can be 1 wt. % to 80 wt. %, or 5 wt. % to 30 wt. %. In this specific example, 10 wt. % PSAA was used.

The carbonization process can be carried out in a reactor under inert gas environment (e.g. flowing N₂ at 1.0 LPM/kg SiNWs-carbon powder with 10% PSAA during the ramping up of the reactor temperature to 700° C., then keeping the temperature at 700° C. for one hour to complete the carbonization of PSAA, and then keeping N₂ flowing to cool down the reactor to a temperature of less than 300° C. before unloading the treated SiNWs-carbon powder from the reactor). The carbonization temperature can be in a range of 450° C. to 900° C. The carbonization time can be 30 min. to 5 hours. The N₂ flow can be varied from 0.1 LPM/kg SiNWs-carbon powder to 5 LPM/kg SiNWs-carbon powder. Purpose of the N₂ flow is to remove air/O₂ and the decomposed gases from the reactor and prevent the carbonized surface coating from being oxidized.

Because PSAA can be readily and uniformly coated on SiNWs-carbon powder surface, i.e. on both graphite and Si nanowire surfaces, the carbonized surface coating is also uniform, e.g. a uniform 1.9 nm coating layer can be observed on both Si nanowire surface and graphite surface after the carbonization treatment in the TEM images of FIGS. 7A and 7B where the Si nanowire has a diameter of 20.7 nm.

Two sets of NCA pouch cells were prepared, the first with PSAA carbonization treatment and the second without treatment.
a) 100 g of a 4 wt. % CMC stock solution (in DI water) was added to a planetary kneader container. The container was kept at 30° C.
b) 46 g of SiNWs-Carbon powder (with carbonized PSAA disposed thereon for the set with PSAA carbonization treatment and without PSAA for the set without treatment) was gradually added to the mixture resulting from step a). The resulting mixture was mixed in the planetary kneader container (Non bubbling kneader, NBK-1) for 15 minutes at 400 rpm.
c) The slurry resulting from step b) was placed in a 40° C. bath for 2 minutes, and was then mixed again to achieve a slurry temperature of 30° C.
d) The slurry resulting from step c) was then used to coat an anode electrode onto a copper foil using a doctor's blade for each of the two NCA cells, the first with PSAA carbonization treatment and the second without treatment. The electrodes were then dried at 90° C. for 60 minutes.
e) After 60 minutes at room temperature, the electrodes resulting from step d) were then calendared to a density of 1.4 g cm³ (typically density between 1 and 1.65 g cm³ can be used).

Two sets of electrochemical cells were built by matching NCA cathodes with SiNWs-carbon powder anode electrodes. The SiNWs-carbon powder anode electrodes were coated with 8 wt. % CMC, and 92 wt. % of SiNWs-Carbon powder containing 9.73 wt. % Si. The first set contained SiNWs-carbon powder with carbonized PSAA and the second set contained SiNWs-carbon powder without any PSAA applied.

The cycling performance of the two sets of electrochemical cells were compared over 500 cycles using different cycling protocols as shown in FIG. 8 and FIG. 9.

The electrochemical cells were subject to simple formation protocol with C/20 for charging current between OCV and 4.25V and with C/20 for discharging current between 4.25V and 2.5V. There was no prelithiation of the electrodes. The cells were characterized at C/10 for one cycle and at C/5 for another cycle. Then the cells were cycled at C/3 for charging and C/3 for discharging for 500 cycles, as shown in FIG. 8 (first cycling protocol). The cell using the anode without treatment exhibited a capacity retention of 71% at 500th cycle. The cell using the anode with treatment showed better cycling and a capacity retention of 74% at 500th cycle. The treatment improved the capacity retention during cycling, which led to a slower capacity decay. In FIG. 9 (second cycling protocol), the cells were cycled at C/3 charging and C/2 discharging. Every 100 cycles, the cells were used at C/10 to check their capacity, which resulted in the capacity spikes indicating the Si nanowires continued to be electrochemically active and full capacity realized at C/10. The two C/10 cycles' capacity check activated the Li ion diffusion channels and hence a slow decay tail followed the capacity spikes. As a result, the cell using the anode without treatment exhibited a capacity retention of 70.5% at 500th cycle. The cell using the anode with treatment showed better cycling and a capacity retention of 75.5% at 500th cycle. This revealed once more that the carbonized PSAA surface treatment improved the cycling behavior, which led to a slower capacity decay.

### Example 5—Cycling of Full Electrochemical Cells (Simile Sided NCA Cathode+Simile Layer SiNWs-Carbon Powder Anode with Simile and Double PSAA Surface Treatments)

Silicon nanowires mechanically and conductively attached to commercial uncoated natural graphite particles with the Si wt. % equal to 9.73% were first coated uniformly using 5˜20% PSAA (e.g., 20% PSAA) and then carbonized at temperatures up to 700° C. following the steps described in Example 4. After the carbonization process, a second surface coating was uniformly applied on the carbonized SiNWs-Carbon powder by using 0.1˜5% PSAA (double surface treatment). In this example 0.3% PSAA by wt. was used. The second PSAA coating was applied following the same procedure described in the prior examples and was not carbonized.

Four sets of electrochemical cells (full cells with SiNWs-carbon powder anodes and NCA cathodes) were prepared to evaluate and compare full cell performances for different types of anodes materials and PSAA coating combinations:
1) Electrochemical cells using anodes with 8 wt. % CMC, and 92 wt. % of SiNWs-Carbon powder with Si wt. % equal to 9.7% (no surface treatment)
2) Electrochemical cells using anodes with 8 wt. % CMC, and 92 wt. % SiNWs-Carbon powder with Si wt. % equal to 9.7% and uniformly coated with a coating layer of 5˜20% PSAA (e.g., 20% PSAA) carbonized at temperatures up to 700° C. (single surface treatment)
3) Electrochemical cells using anodes with only 5 wt. % CMC, 5 wt. % C65 Carbon Black conductive additive (from IMERYS Graphite & Carbon), and 90 wt. % SiNWs-Carbon powder with Si wt. % equal to 9.7% and uniformly coated with a coating layer using 5˜20% PSAA (e.g., 20% PSAA) carbonized at temperatures up to 700° C. (single surface treatment).
4) Electrochemical cells using anodes with only 5 wt. % CMC, 5 wt. % C65 Carbon Black conductive additive (from IMERYS Graphite & Carbon), and 90 wt. % SiNWs-Carbon powder with Si wt. % equal to 9.7% and uniformly coated with a first coating layer using 5˜20% PSAA (e.g., 20% PSAA) carbonized at temperatures up to 700° C. and then uniformly coated with a second coating layer using 0.1˜5% PSAA (e.g., 0.3% by wt.) not carbonized (double surface treatment).

A summary of the four (4) sets of Electrochemical cells outlining the types of anode materials used in each set and the initial cells performances are presented in FIG. 10.

The Electrochemical cells underwent a simple formation process at C/20 for charging between OCV and 4.25V and at C/20 for discharging between 4.25V and 2.5V. There was no prelithiation for the anode and the cathode. The cells were characterized at C/10 for one cycle and at C/5 for another cycle. The cells were cycled at C/3 for charging and C/3 for discharging for 500 cycles. FIGS. 11 and 12 includes two charts comparing discharge specific capacity and capacity retention between the third type of Electrochemical cells (single surface treatment with carbonized surface, 5% CMC) and the fourth Electrochemical cells (double surface treatment with 0.3% PSAA coated on carbonized surface, 5% CMC) as described in the prior paragraphs.

The cycling performance were compared over 500 cycles using different cycling protocols. The charts in FIGS. 11 and 12 show the discharge specific capacity and the % capacity retention between over 500 cycles for Electrochemical cells with single surface treatment and the Electrochemical cells with double surface treatment.

From the charts it can be inferred that the Electrochemical cells with the double surface treatment exhibit more stable cycling performance compared to the Electrochemical cells with single surface treatment. As shown on the charts, the reversible capacity of 400 mAh/g is reached after 200 cycles for those cells with single surface treatment and it is reached after 400 cycles for those cells with double surface treatment.

The double surface treatment enables to use less polymer binder (e.g., 5% CMC only) which results into improved cell performance stability. Without wishing to be bound by theory, the inventors have hypothesized that the double surface treatment reduce the surface area and stabilize the interface between the materials and the electrolyte.

These novel PSAA surface coatings in accordance with aspects of the invention can be applied to silicon nanowires, graphite particles or other kinds of particles (e.g., carbon, metal or its oxides or alloys). These coatings contribute to render uniform the surfaces of the silicon nanowires and the graphite particles. The greater surface uniformity improves the SEI formation, contributing to better stability and cycling performance. The PSAA coatings in accordance with aspects of the invention are inexpensive and provide a convenient way to apply a uniform surface treatment to SiNWs-carbon powder materials without the use of additional milling processes to break down the powders. The PSAA surface coatings applied uniformly to both the silicon nanowires and the graphite particles can optionally be carbonized in accordance with aspects of the present invention so to create a uniform carbon coating layer to the silicon nanowires and the graphite particles which allows for the reduction for the need for conductive additive and enhancement of the interactions (affinity) with different binder polymers in the electrodes.

While specific embodiments of the invention have been described herein for the purpose of reference and illustration, various modifications will be apparent to a person skilled in the art without departing from the scope of the invention as defined by the appended claims.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. These and other changes can be made to the disclosure in light of the detailed description. All such modifications are intended to be included within the scope of the appended claims.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

What is claimed is:

1. A composite comprising a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol.

2. The composite of claim 1, wherein the polymer has a softening point of less than 200° C.

3. The composite of claim 1, wherein the polymer is insoluble in water.

4. The composite of claim 1, wherein the polymer is soluble in alcohol.

5. The composite of claim 4, wherein the alcohol comprises ethanol.

6. The composite of claim 1, wherein the polymer is poly(styrene-co-allyl alcohol).

7. The composite of claim 1, wherein the polymer comprises at least 25 mol % of monomeric units formed from allyl alcohol.

8. The composite of claim 1, wherein the composite comprises 0.1 wt % to 10 wt % of the polymer.

9. The composite of claim 1, wherein the composite comprises 0.5 wt % to 5 wt % of the polymer.

10. The composite of claim 1, wherein the plurality of silicon-based nanostructures are silicon nanowires, silicon nanoparticles or a combination thereof.

11. The composite of claim 1, wherein the plurality of silicon-based nanostructures are silicon nanowires

12. The composite of claim 10, wherein the silicon nanowires have diameters in the range of 10 nm to 200 nm.

13. The composite of claim 1, wherein the plurality of silicon-based nanostructures comprise a monocrystalline core and a shell layer, wherein the shell layer comprises amorphous silicon, polycrystalline silicon, or a combination thereof.

14. The composite of claim 1, wherein the composite comprises at least 90 wt % of the silicon-based nanostructures attached to the carbon-based substrate.

15. The composite of claim 1, wherein the composite comprises at least 95 wt % of the silicon-based nanostructures attached to the carbon-based substrate.

16. The composite of claim 1, wherein the carbon-based substrate is a carbon-based powder.

17. The composite of claim 15, wherein the carbon-based powder has a D₅₀ of 5 μm to 50 μm.

18. The composite of claim 1, wherein the carbon-based substrate is selected from the group consisting of graphite powder, mesocarbon microbead powder or a combination thereof.

19. The composite of claim 1, wherein the carbon-based substrate is graphite powder.

20. The composite of claim 1, wherein the carbon-based substrate is graphite powder, the graphite powder comprising a plurality of graphite particles, each particle comprising a plurality of pores disposed therein, wherein the silicon-based nanostructures are attached to surfaces defining said pores.

21. The composite of claim 1, wherein the carbon-based substrate is graphite powder comprising uncoated, natural graphite particles.

22. The composite of claim 1, wherein the plurality of silicon-based nanostructures attached to a carbon-based substrate comprise 1 wt % to 40 wt % silicon.

23. The composite of claim 1, wherein the plurality of silicon-based nanostructures attached to a carbon-based substrate comprises 2.5 wt % to 25 wt % silicon.

24. The composite of claim 23, wherein the plurality of silicon-based nanostructures attached to a carbon-based substrate comprises 5 wt % to 15 wt % silicon.

25. The composite of claim 1, wherein the plurality of silicon-based nanostructures and the carbon-based substrate further comprise a conductive carbon coating, wherein the polymer comprising monomeric units formed from styrene and allyl alcohol is disposed on the conductive carbon coating.

26. The composite of claim 25, wherein the conductive carbon coating comprises carbonized PSAA.

27. The composite of claim 26, wherein the conductive carbon coating is provided as an inner coating layer on the plurality of silicon-based nanostructures and the carbon-based substrate, and the polymer comprising monomeric units formed from styrene and allyl alcohol is provided as an outer coating layer on the plurality of silicon-based nanostructures and the carbon-based substrate.

28. A process for preparing a composite, the process comprising:
mixing:
a plurality of silicon-based nanostructures attached to a carbon-based substrate, and
a solution of a polymer, the polymer comprising monomeric units formed from styrene and allyl alcohol; and
drying the mixture resulting from the mixing.

29. The process of claim 27, wherein the solution of the polymer comprises the polymer and an alcoholic solvent.

30. The process of claim 29, wherein the alcoholic solvent comprises ethanol.

31. The process of claim 27, wherein the solution of the polymer does not comprise water.

32. The process of claim 27, wherein the solution comprises 0.05 wt % to 10 wt % of the polymer.

33. The process of claim 27, wherein the solution comprises 0.1 wt % to 3 wt % of the polymer.

34. The process of claim 33, wherein the solution comprises (e.g. 0.5 wt % to 1.5 wt %). of the polymer.

35. The process of claim 27, wherein the drying is conducted at a temperature of 20° C. to 150° C., at ambient or reduced pressure (e.g. under vacuum).

36. The process of claim 35, wherein the drying is conducted under vacuum.

37. The process of claim 27, wherein the drying is conducted at a temperature of 30° C. to 130° C.

38. The process of claim 37, wherein the drying is conducted under an inert gas.

39. The process of claim 38, wherein the drying is conducted under nitrogen.

40. The process of claim 27, wherein the plurality of silicon-based nanostructures attached to a carbon-based substrate comprise a conductive carbon coating.

41. The process of claim 40, wherein the conductive carbon coating is formed by carbonizing a polymeric coating predisposed on the silicon-based nanostructures and the carbon-based substrate.

42. The process of claim 41, wherein the polymeric coating predisposed on the silicon-based nanostructures and the carbon-based substrate is a polymer comprising monomeric units formed from styrene and allyl alcohol.

43. The process of claim 41, where carbonizing the polymeric coating predisposed on the silicon-based nanostructures and the carbon-based substrate comprises heating the silicon-based nanostructures and the carbon-based substrate having the polymeric coating predisposed thereon at a temperature of 200° C. to 750° C.

44. The process of claim 43, wherein the heating is conducted at a temperature of 500° C. to 750° C.

45. The process of claim 43, wherein the heating is conducted under an inert gas.

46. The process of claim 45, wherein the heating is conducted under nitrogen.

47. An anode electrode comprising a first anodic layer, the first anodic layer comprising a binder and a composite comprising a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol.

48. The anode electrode of claim 47, wherein the binder is selected from the group consisting of styrene butadiene rubber (SBR), carboxymethyl cellulose (CMC), poly(vinylidene fluoride) (PVDF), poly(acrylic acid) (PAA), poly(acrylonitrile) (PAN), poly(acrylamide-co-diallyldimethylammonium) (PAADAA), poly(tetrafluoroethylene) (PTFE), and a combination of two or more thereof.

49. The anode electrode of claim 47, wherein the binder is a mixture of styrene butadiene rubber (SBR) and carboxymethyl cellulose (CMC).

50. The anode electrode of claim 49, wherein the binder comprises 30 wt % to 70 wt % of butadiene rubber (SBR) and 30 wt % to 70 wt % of carboxymethyl cellulose (CMC).

51. The anode electrode of claim 47, wherein the binder is poly(tetrafluoroethylene) (PTFE).

52. The anode electrode of claim 47, wherein the first anodic layer comprises 0.5 wt % to 10 wt % of the binder.

53. The anode electrode of claim 47, wherein the first anodic layer comprises 1 wt % to 6 wt % of the binder.

54. The anode electrode of claim 47, wherein the first anodic layer comprises at least 90 wt % of the composite.

55. The anode electrode of claim 47, wherein the first anodic layer further comprises a conductive additive.

56. The anode electrode of claim 55, wherein first anodic layer comprises 0.2 wt % to 5 wt % of the conductive additive.

57. The anode electrode of claim 55, wherein the conductive additive is selected from the group consisting of carbon black particles, carbon nanofibers, carbon nanotubes, and a combination of two or more thereof.

58. The anode electrode of claim 47, wherein the anode electrode further comprises a current collector.

59. The anode electrode of claim 58, wherein the current collector is a copper foil or a carbon-coated copper foil.

60. The anode electrode of claim 47, further comprising one or more additional anodic layers, each additional anodic layer independently comprising an active material and a binder.

61. The anode electrode of claim 60, wherein the first anodic layer comprises a first surface configured to contact (or being in contact with) a current collector, and a second surface in contact with the one or more additional anodic layers.

62. The anode electrode of claim 61, wherein the first anodic layer comprises a first surface in contact with a current collector.

63. The anode electrode of claim 61, wherein the second surface of the first anodic layer comprises metallic lithium disposed thereon.

64. The anode electrode of claim 63, wherein the metallic lithium is selected from lithium metal foil, stabilized lithium metal powder, and a combination thereof.

65. The anode electrode of claim 60, wherein the active material is selected from the group consisting of a graphite powder, a plurality of silicon-based nanostructures attached to a carbon-based substrate, a composite comprising a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol, and a combination of two or more thereof.

66. The anode electrode of claim 65, wherein at least one of the one or more additional anodic layers further comprise a conductive additive, wherein the conductive additive is selected from the group consisting of carbon black particles, carbon nanofibers, carbon nanotubes, and a combination of two or more thereof.

67. A process for preparing an anode electrode, the process comprising:
mixing:
a composite comprising a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol, and
a binder to form a mixture;
applying a layer of the mixture.

68. The process of claim 67, wherein the layer is configured to be in contact with a current collector.

69. The process of claim 67, wherein the mixture is provided as a wet slurry and the process further comprises drying the layer.

70. The process of claim 67, wherein the mixture is provided as a solid and the applying comprises forming a layer of the solid mixture.

71. The process of claim 70, wherein the forming comprises extruding or calendaring.

72. The process of claim 67, wherein the applying comprises applying a layer of the mixture onto a current collector.

73. The process of claim 72, further comprising applying one or more additional anodic layers onto the layer, wherein the one or more additional anodic layers each independently comprise an active material and a binder.

74. The process of claim 73, wherein the active material is selected from the group consisting of a graphite powder, a plurality of silicon-based nanostructures attached to a carbon-based substrate, a composite comprising a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol, and a combination of two or more thereof.

75. The process of claim 74, wherein at least one of the one or more additional anodic layers further comprise a conductive additive, wherein the conductive additive is selected from the group consisting of carbon black particles, carbon nanofibers, carbon nanotubes, and a combination of two or more thereof.

76. A battery comprising:
a composite comprising a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol.

77. The battery of claim 76, wherein the battery is a lithium ion battery.

78. A battery comprising:
an anode electrode comprising a first anodic layer, the first anodic layer comprising a binder and a composite comprising a plurality of silicon-based nanostructures attached to a carbon-based substrate, the plurality of silicon-based nanostructures and the carbon-based substrate having a polymer disposed thereon, wherein the polymer comprises monomeric units formed from styrene and allyl alcohol.

79. The battery of claim 78, wherein the battery is a lithium ion battery.
